(19) United States
(12) Patent Application Publication
(10) Pub. No.: US 2009/0285959 A1
(43) Pub. Date: Nov. 19, 2009

(54) FLAVOR-IMPROVING AGENT AND FOOD CONTAINING THE FLAVOR-IMPROVING AGENT

(76) Inventors: Ryoichi MINOSHIMA, Kanagawa (JP); Toshiaki Aoyama, Kanagawa (JP)

Correspondence Address: Muncy, Geissler, Olds & Lowe, PLLC, P.O. BOX 1364, FAIRFAX, VA, 22038-1364, US

(21) Appl. No.: 12/536,215

(22) Filed: Aug. 5, 2009

Related U.S. Application Data
(63) Continuation of application No. PCT/JP2008/051756, filed on Feb. 4, 2008.

(30) Foreign Application Priority Data
Feb. 8, 2007 (JP) 2007-029454

(51) Int. Cl. A23L 1/20; A23L 2/38

(52) U.S. Cl. 426/534; 426/459; 426/634; 426/598

(57) ABSTRACT

The present invention is directed to: a flavor improving agent for food including at least one selected from germinated whole fat soybean powder, and enzyme-inactivation-untreated ungerminated whole fat soybean powder; a flavor improving agent for food in which the germinated whole fat soybean powder is a product in a form of a powder of germinated soybean, a product in a form of a powder of a germinated soymilk, or a product in a form of a powder of a germinated whole grain soymilk; and a food produced by adding to a food or an intermediary material of the food in a production step of the food, the flavor improving agent in an amount accounting for 0.1 to 20% by mass of the solid content of the food or the solid content of the intermediary material of the food.

### CROSS-REFERENCE TO RELATED APPLICATIONS

The present application is a continuation of PCT Application No. PCT/JP2008/051756, filed on Feb. 4, 2008, which claims priority to Japanese Patent Application No. 2007-029454, filed on Feb. 8, 2007, the entire contents of which being hereby incorporated herein by reference.

### BACKGROUND OF THE INVENTION

1. Field of the Invention

The present invention relates to a flavor improving agent for foods such as soybean protein, enzyme-inactivation-treated ungerminated whole fat soybean powder, enzyme-inactivation-treated ungerminated defatted soybean powder, enzyme-inactivation-untreated ungerminated defatted soybean powder, soybean processed food, wheat protein, wheat flour wheat flour processed food, milk protein, dairy product, processed marine product and processed livestock product; a food containing the flavor improving agent; and a method for producing the food.

2. Related Art

Foods and beverages including soybean as a main material, such as soymilk, soybean powder beverages, peptide beverages and the like (hereinafter, referred to as soybean processed food) often have a peculiar astringent taste, acrid taste, and bitter taste derived from soybean. Therefore, improvement of the flavor of soybean processed foods has been highly demanded. In addition, techniques of masking or improving the flavor by a physical and/or chemical treatment or use of additives for fishy smell of dairy products and milk beverages, fishy flavor of seafoods, livestock meat and the like, as well as other foods and beverages have been proposed up to now.

For example, Japanese Unexamined Patent Application, First Publication No. 2006-280310 discloses a method for improving the flavor of soybean foods and beverages by adding a saccharide composition including tri to tetrasaccharide having a branched structure. However, this saccharide composition having a branched structure has been problematic in having a high cost since fractionation or purification from isomalt oligosaccharide and the like is required.

Moreover, Japanese Unexamined Patent Application, First Publication No. 2006-191826 discloses a method for improving flavor by adding a solvent extract of roast barley to dairy products, milk-including foods, grain-including foods, seafoods, milk based beverages and soymilk. However, the solvent extract of roast barley is an extracted product of roast barley with various types of ethanol, thereby leading to problems of high cost due to the recovery expense of ethanol and the like for extraction, the extraction expense and the like.

Furthermore, Japanese Patent No. 3701281 discloses a baked confectionery prepared by adding soybean whole grain powder having a favorable flavor. Although whole fat soybean powder subjected to an enzyme-inactivating treatment is added in this case, improvement of flavor by whole fat soybean powder not subjected to an enzyme-inactivating treatment has not been studied at all.

### SUMMARY OF THE INVENTION

An object of the present invention is to provide a comparatively inexpensive flavor improving agent which can be produced without using an organic solvent, and without carrying out such a treatment as fractionation, solvent recovery, and the like in production. In addition, another object of the present invention is to provide a method for producing a food having an improved flavor obtained by adding the flavor improving agent.

The present inventors have thoroughly investigated in order to solve the foregoing problems, and consequently found that the addition of a particular soybean powder with or without carrying out a particular treatment after the addition can solve the aforementioned problems. Accordingly, the present invention was achieved.

More specifically, in a first aspect of the present invention, a method of using at least one selected from germinated whole fat soybean powder, and enzyme-inactivation-untreated ungerminated whole fat soybean powder (C) to produce a flavor improved food.

According to a second aspect of the present invention, in the method according to the first aspect, the germinated whole fat soybean powder is a product in a form of a powder of one selected from a germinated soymilk, and a germinated whole grain soymilk.

According to a third aspect of the present invention, in the method according to the first or second aspect, the germinated whole fat soybean powder is a product not subjected to an enzyme-inactivation treatment (B).

According to a fourth aspect of the present invention, in the method according to the third aspect, a composition is formed by adding at least one kind of soybean powder selected from enzyme-inactivation-untreated germinated whole fat soybean powder (B), and enzyme-inactivation-untreated ungerminated whole fat soybean powder (C), to one selected from a food (e1), and an intermediary material of the food obtained in a production step of the food (e2), in an amount equal to 0.1 to 20% by mass of one selected from a solid content of the food (e1), and a solid content of the intermediary material of the food (e2); followed by keeping the composition in the presence of moisture for 10 min to 30 hrs to form a moisture treated composition; followed by subjecting the moisture treated composition to an enzyme-inactivation treatment.

According to a fifth aspect of the present invention, in the method according to any one of the first to fourth aspects, the food is any one selected from the group consisting of soybean protein, enzyme-inactivation-treated ungerminated whole fat soybean powder (a), enzyme-inactivation-treated ungerminated defatted soybean powder (b), enzyme-inactivation-untreated ungerminated defatted soybean powder (c), soybean processed food, wheat protein, wheat flour, wheat flour processed food, milk protein, a dairy product, a processed marine product, and a processed livestock product.

In a sixth aspect of the present invention, a germinated whole fat soybean powder (B) that is a germinated soybean powder, and is not subjected to an enzyme-inactivation treatment.

According to a seventh aspect of the present invention, in the germinated whole fat soybean powder according to the sixth aspect, the germinated whole fat soybean powder (B) is a product in a form of a powder of one selected from an enzyme-inactivation-untreated germinated soymilk, and an enzyme-inactivation-untreated germinated whole grain soymilk.

According to an eighth aspect of the present invention, in an improved flavor food that is produced by adding to a food (e1) or an intermediary material of a food in a production step of the food (e2), the germinated whole fat soybean powder (B) according to the sixth or seventh aspect in an amount accounting for 0.1 to 20% by mass of the solid content of the food (e1) or the solid content of the intermediary material of the food (e2).

According to a ninth aspect of the present invention, in the improved flavor food according to the eighth aspect, the food is any one selected from the group consisting of soybean protein, enzyme-inactivation-treated ungerminated whole fat soybean powder (a), enzyme-inactivation-treated ungerminated defatted soybean powder (b), enzyme-inactivation-untreated ungerminated defatted soybean powder (c), soybean processed food, wheat protein, wheat flour, wheat flour processed food, milk protein, a dairy product, a processed marine product, and a processed livestock product.

In a tenth aspect of the present invention, a method for producing an improved flavor soybean powder includes steps of adding to at least one kind of soybean powder selected from enzyme-inactivation-treated ungerminated whole fat soybean powder (a), enzyme-inactivation-treated ungerminated defatted soybean powder (b) and enzyme-inactivation-untreated ungerminated defatted soybean powder (c): an enzyme-inactivation-treated germinated whole fat soybean powder (A) in an amount accounting for 0.1 to 20% by mass of the amount of the soybean powder; and mixing therewith.

According to an eleventh aspect of the present invention, in the method for producing improved flavor soybean powder according to the tenth aspect, the enzyme-inactivation-treated germinated whole fat soybean powder (A) is a product in a form of a powder of an enzyme-inactivation-treated germinated soymilk, or an enzyme-inactivation-treated germinated whole grain soymilk.

In a twelfth aspect of the present invention, a method for producing an improved flavor soybean powder, includes the steps of: (1) forming a moisture treated composition by bringing at least one kind of a first soybean powder selected from enzyme-inactivation-treated ungerminated whole fat soybean powder (a), enzyme-inactivation-treated ungerminated defatted soybean powder (b), and enzyme-inactivation-untreated ungerminated defatted soybean powder (c) into contact with an amount, equal to 0.1 to 20% by mass of an amount of the first soybean powder, of one kind of a second soybean powder selected from enzyme-inactivation-untreated germinated whole fat soybean powder (B), and enzyme-inactivation-untreated ungerminated whole fat soybean powder (C), in the presence of moisture for 10 min to 30 hrs; (2) subjecting the moisture treated composition to an enzyme-inactivation treatment to form an enzyme-inactivation moisture treated composition; and (3) subjecting the enzyme-inactivation moisture treated composition to a drying treatment.

According to a thirteenth aspect of the present invention, in the method for producing an improved flavor soybean powder according to the twelfth aspect, the enzyme-inactivation-untreated germinated whole fat soybean powder (B) is a product in a form of a powder of one selected from an enzyme-inactivation-untreated germinated soymilk, and an enzyme-inactivation-untreated germinated whole grain soymilk.

According to a fourteenth aspect of the present invention, in the method for producing an improved flavor soybean powder according to the twelfth aspect, the enzyme-inactivation-untreated ungerminated whole fat soybean powder (C) is a product in a form of a powder of one selected from an enzyme-inactivation-untreated soymilk, and an enzyme-inactivation-untreated whole grain soymilk.

In a fifteenth aspect of the present invention, a method for producing an improved flavor food, includes the steps of: forming a composition by adding at least one kind of soybean powder selected from enzyme-inactivation-untreated germinated whole fat soybean powder (B), and enzyme-inactivation-untreated ungerminated whole fat soybean powder (C), to one selected from a food (e1), and an intermediary material of the food obtained in a production step of the food (e2), in an amount equal to 0.1 to 20% by mass of one selected from a solid content of the food (e1), and a solid content of the intermediary material of the food (e2); followed by keeping the composition in the presence of moisture for 10 min to 30 hrs to form a moisture treated composition; followed subjecting the moisture treated composition to an enzyme-inactivation treatment.

According to a sixteenth aspect of the present invention, in the method for producing an improved flavor food according to the fifteenth aspect, the food is one selected from a soymilk (d1), and a whole grain soymilk (d2).

According to a seventeenth aspect of the present invention, in the method for producing an improved flavor food according to the fifteenth aspect, the production step of the food is a step of producing a soymilk, and the intermediary material of the food (e2) is a liquid prepared by removing bean curd refuse from a bean slurry obtained by grinding soybeans.

According to a eighteenth aspect of the present invention, in the method for producing an improved flavor food according to the fifteenth aspect, the production step of the food is a step of producing a whole grain soymilk, and the intermediary material of the food (e2) is a bean slurry obtained by grinding soybeans.

In a nineteenth aspect of the present invention, a flavor improving agent for food includes at least one selected from germinated whole fat soybean powder, and enzyme-inactivation-untreated ungerminated whole fat soybean powder (C).

According to a twentieth aspect of the present invention, in the flavor improving agent according to the nineteenth aspect, the germinated whole fat soybean powder is a product in a form of a powder of a germinated soymilk or a germinated whole grain soymilk.

According to a twenty-first aspect of the present invention, in the flavor improving agent according to the nineteenth or twentieth aspect, the germinated whole fat soybean powder is a product not subjected to an enzyme-inactivating treatment (B).

According to a twenty-second aspect of the present invention, in the flavor improving agent according to any one of the nineteenth to twenty-first aspects, the food is any one selected from the group consisting of soybean protein, enzyme-inactivation-treated ungerminated whole fat soybean powder (a), enzyme-inactivation-treated ungerminated defatted soybean powder (b), enzyme-inactivation-untreated ungerminated defatted soybean powder (c), soybean processed food, wheat protein, wheat flour, wheat flour processed food, milk protein, a dairy product, a processed marine product, and a processed livestock product.

In a twenty-third aspect of the present invention, an improved flavor food that is produced by adding to a food (e1) or an intermediary material of a food in a production step of the food (e2), the flavor improving agent according to any one of the nineteenth to twenty-second aspects in an amount accounting for 0.1 to 20% by mass of the solid content of the food (e1) or the solid content of the intermediary material of the food (e2).

Addition of the flavor improving agent of the present invention with or without carrying out a particular treatment after the addition leads to an effect to improve the flavor by reducing an unpleasant flavor specific to soybean such as an astringent taste, acrid taste, bitter taste, and the like of soybean processed foods such as soybean protein, soybean powder, soymilk and the like, as well as fishy flavor and smell in denaturing of milk protein, and dairy products, etc., and the fishy flavor of livestock meat. Especially, addition of the flavor improving agent of the present invention to the soybean processed food such as soybean protein, soybean powder, soymilk and the like, with or without carrying out a particular treatment after the addition, can achieve a prominent effect of improving the flavor.

### DETAILED DESCRIPTION OF THE INVENTION

Herein, the agent according to the present invention added for improving a flavor, or the product to have an improved flavor by adding the agent according to the present invention is designated by a symbol following each term as needed. For example, the enzyme-inactivation-treated germinated whole fat soybean powder is designated by (A); the enzyme-inactivation-untreated germinated whole fat soybean powder is designated by (B); the enzyme-inactivation-untreated ungerminated whole fat soybean powder is designated by (C); the enzyme-inactivation-treated ungerminated whole fat soybean powder is designated by (a); the enzyme-inactivation-treated ungerminated defatted soybean powder is designated by (b); the enzyme-inactivation-untreated ungerminated defatted soybean powder is designated by (c); the soymilk is designated by (d1); the whole grain soymilk is designated by (d2); and the food is designated by (e1) and the intermediary material of the food is designated by (e2). However, these symbols are just for helping to understand the present invention, and should not be construed as a limitation on the scope of present invention.

The flavor improving agent for food of the present invention is first explained. The flavor improving agent for food of the present invention includes at least one selected from germinated whole fat soybean powder, and enzyme-inactivation-untreated ungerminated whole fat soybean powder (C).

Here, the germinated whole fat soybean powder that can be used may be either enzyme-inactivation-untreated, or enzyme-inactivation-treated. However, one which was not subjected to an enzyme-inactivating treatment is preferably used for further improving the flavor of the food.

Defatted soybean is not used for the flavor improving agent of the present invention, because an extracting treatment with hexane is carried out to prepare the defatted soybean, whereby the flavor of food cannot be improved due to the influences from the remaining extract with hexane.

The enzyme-inactivating treatment according to the present invention herein refers to a treatment that leads to the lipoxygenase activity of 0 units. For example, the treatment may be an enzyme-inactivating treatment by heating, an enzyme-inactivating treatment by adding a reagent, and the like. The lipoxygenase activity can be determined by an extinction method using linoleic acid as a substrate.

The enzyme-inactivating treatment by heating may be carried out at a heating temperature of preferably 80° C. to 150° C., more preferably 80 to 145° C., and most preferably 110 to 140° C. The heating time period is preferably 1 sec to 6 hrs, more preferably 2 sec to 3 hrs, and most preferably 2 sec to 1 hour. When the enzyme-inactivating treatment time period is within 1 min, the heating temperature is preferably 100 to 150° C.

In addition, the soybean powder or the like subjected to the enzyme-inactivating treatment is preferably in a state having moisture. Specifically, the moisture content upon being subjected to the enzyme-inactivating treatment of the material is preferably 20 to 90% by mass, more preferably 20 to 70% by mass, and most preferably 20 to 50% by mass.

In a specific method of the enzyme-inactivating treatment, when a solid is subjected to the treatment, heating is carried out at a temperature of preferably 80 to 150° C., more preferably 80 to 120° C., and most preferably 100 to 120° C., for preferably 1 sec to 6 hrs, more preferably 3 sec to 1 hour, and most preferably 5 sec to 1 hour using hot air, steam or the like.

Furthermore, when a liquid is subjected to the treatment, heating is carried out by the method at a temperature of preferably 100 to 150° C., more preferably 110 to 140° C., and most preferably 110 to 135° C., for preferably 1 sec to 1 minute, more preferably 2 sec to 30 sec, and most preferably 2 sec to 10 sec using a UHT sterilizer.

When soybean powder is produced by drying with a spray drying process of an aqueous solution containing a soybean solid matter in which lipoxygenase is not inactivated, although the aqueous solution may be briefly heated during the process of forming a powder, the temperature of the aqueous solution itself containing the soybean solid matter is not elevated to the preset temperature at the inlet of the spray drying apparatus through generation of vaporization heat. Thus, lipoxygenase in the soybean powder is not inactivated, and its activity fails to fall to 0 units. Therefore, drying by way of a spray drying process does not fall under the enzyme-inactivating treatment of the present invention.

Furthermore, the enzyme-inactivating treatment by adding a reagent is carried out by addition of a reagent such as an acidic aqueous solution of hypochlorous acid, etc., or an alkaline aqueous solution to an object the enzyme of which is to be inactivated; however, the enzyme-inactivating treatment by heating is more preferred owing to the problems of the remaining reagent, and the like.

Next, the germinated whole fat soybean powder is explained. The germinated whole fat soybean powder is the powder of germinated soybean, and can be obtained by grinding of germinated soybean, or can also be obtained by drying a germinated soymilk, or by drying a germinated whole grain soymilk. In addition, any of the germinated whole fat soybean powder subjected to an enzyme-inactivating treatment (A), and that not subjected to an enzyme-inactivating treatment (B) can be used. It is more preferred to use enzyme-inactivation-untreated germinated whole fat soybean powder (B) for achieving a more favorable effect of improvement of the flavor.

With respect to a soybean cultivar used as a raw material of the germinated soybean to be produced in a form of a powder, any one of domestic soybeans such as Enrei, Ryuho, Toyohomare, and Miyagishirome, foreign-grown soybeans such as IOM, genetically modified soybean, and genetically unmodified soybean can be used. Examples of the foreign-grown soybean include, for example, an article of trade: Landmark, manufactured by Nisshin OilliO Group, Ltd.

Next, a method for producing the germinated soybean is explained by way of examples, but the germinated soybean that can be used in the present invention is not limited to those produced by the production method described below.

Soybean is soaked in water, and allowed to be germinated according to a soybean germination process including: soaking in water or warm water of 10 to 40° C., preferably 15 to 35° C., more preferably 20 to 30° C. for 0.5 to 36 hrs, preferably 1 to 10 hrs, more preferably 1 to 5 hrs, and exposing the soybean to air or oxygen for 10 to 120 hrs, preferably 10 to 48 hrs, and more preferably 12 to 24 hrs during or following the soaking.

When the soybean is exposed to the air or oxygen during the soaking bubbling of the air or oxygen into water or warm water is preferred since the germination is promoted. In this case, the amount of bubbling of the air or oxygen is preferably from 50 ml/min to 3000 ml/min per 100 g mass of the soybean before the soaking step, and the bubbling may be carried out either continuously or intermittently.

The germination percentage of the germination-treated soybean used in the present invention is preferably 10% to 100%, more preferably 20% to 100%, and most preferably 30% to 95%.

The germination percentage referred to herein is a proportion of the number of soybean grains actually germinated among 100 soybean grains, and can be calculated by the following formula. Germination Percentage (%)=Number of Germinated Soybean Grains/100 grains×100=Number of Germinated Soybean Grains

The term “germination” has been defined variously such as initiation of growth and development of plant bud, pollen, seed or spore (“Daijirin”, second edition, Sanseido Book Store Ltd.); growth of each organ of germ differentiated in seeds (author: Yoshio MASUDA, “Plant Physiology”, revised 14th edition, Baifukan Co., Ltd., October 2001, p. 51-57), and the like. However, the term “germination” according to the present invention refers to “a state in which the sprout or root has emerged from the soybean through breaking the skin”. The number of germinated soybean grains in the formula refers to the number of the soybean grains that have actually germinated among 100 soybean grains arbitrarily extracted from among the soybean grains subjected to the germination treatment.

Next, a method for producing the germinated whole fat soybean powder using germinated soybean as a raw material is explained by way of examples, but the germinated whole fat soybean powder that can be used in the present invention is not limited to the product obtained by the following production method.

The germinated soybean is dried by hot air at preferably 40 to 70° C., more preferably 50 to 70° C., and most preferably 60° C. to 70° C., for preferably 1 hour to 72 hrs, more preferably 6 hrs to 48 hrs, and most preferably 12 hrs to 18 hrs to produce dried germinated soybean. The enzyme-inactivation-untreated germinated whole fat soybean powder (B) can be produced by grinding thus resulting dried germinated soybean with a grinder mill such as a hammer mill, jet mill, bead mill, or the like. In addition, the enzyme-inactivation-treated germinated whole fat soybean powder (A) can be produced by an enzyme-inactivating treatment, specifically, by heating at 120° C. for 10 sec with an apparatus for heating while applying pressure before or after grinding of the dried germinated soybean.

In another production method, after carrying out the germination treatment as previously explained, water is added to thus resulting germinated soybean in an amount of 2 to 5 times the mass of the germinated soybean, and the soybean is subjected to a grinding treatment twice with a Mass Colloider (manufactured by Masuko Sangyo Co., Ltd.) to produce bean slurry (may be referred to as ‘go’). The thus resulting bean slurry is subjected to homogenizer treatment with a pressure of preferably 5 to 50 MPa, and thereafter dried by a spray drying process (preset temperature at the inlet: 140 to 180° C., preset temperature at the outlet: 50 to 70° C.), whereby the enzyme-inactivation-untreated germinated whole fat soybean powder (B) can be produced. In addition, the enzyme-inactivation-treated germinated whole fat soybean powder (A) can be produced by subjecting thus resulting enzyme-inactivation-untreated germinated whole fat soybean powder (B) to an enzyme-inactivating treatment, specifically, by heating at 100° C. for 1 hour with a hot-air heating apparatus.

In the present invention, either the enzyme-inactivation-untreated germinated whole fat soybean powder (B), or the enzyme-inactivation-treated germinated whole fat soybean powder (A) can be used; however, in order to achieve a more favorable effect of improving the flavor, it is preferred that after adding the enzyme-inactivation-untreated germinated whole fat soybean powder (B) to a food (e1), or an intermediary material of a food in a production step of the food (e2), keeping in the presence of moisture for 10 min to 30 hrs, and thereafter an enzyme-inactivating treatment is carried out.

Next, germinated soymilk, and germinated whole grain soymilk are explained. The germinated soymilk refers to a soymilk produced from a germinated soybean by removing bean curd refuse in the production process, and a commercialized product can be used. Examples of the commercialized product include an article of trade “GABA Shuukan” manufactured by Nisshin OilliO Group, Ltd., and the like.

A method for producing the germinated soymilk is explained below by way of examples, but the germinated soymilk that can be used in the present invention is not limited to the product obtained by the following production method.

After washing the germinated soybean with water once, preferably twice, and more preferably three times, 1 to 5 times, preferably 1.5 to 3 times, and more preferably 1.5 to 2 times by mass of water is added to the mass of the germinated soybean, and grinding is carried out once to twice with a Mass Colloider while adjusting the slit width, thereby producing bean slurry. The enzyme-inactivation-untreated germinated soymilk can be produced by subjecting thus obtained bean slurry to a centrifugal separation treatment under a condition of 500 rpm, preferably 1000 rpm, and more preferably 1500 rpm to remove bean curd refuse.

The bean curd refuse can be also removed by carrying out a filtration treatment using a filter press at a pressure of 0.01 to 0.05 MPa. In addition, after removing bean curd refuse from the bean slurry, the liquid may be treated with a homogenizer at a pressure of preferably 5 to 50 MPa, more preferably 10 to 40 MPa, and most preferably 15 to 30 MPa.

Moreover, the enzyme-inactivation-treated germinated soymilk can be produced by an enzyme-inactivating treatment, specifically, by heating at a temperature of preferably 100 to 150° C., more preferably 110 to 140° C., and most preferably 110 to 135° C. for preferably 1 sec to 1 minute, more preferably 2 sec to 30 sec, and most preferably 2 sec to 10 sec with a UHT sterilizer, before or after removing bean curd refuse from the bean slurry.

The germinated whole grain soymilk refers to a whole grain soymilk produced from germinated soybean, in which bean curd refuse is not removed during production, and a commercialized product can be used. A method for producing the germinated whole grain soymilk is explained below by way of examples, but the germinated whole grain soymilk that can be used in the present invention is not limited to the product obtained by the following production method.

After washing the germinated soybean with water once, preferably twice, more preferably three times, 1 to 5 times, preferably 1.5 to 3 times, and more preferably 1.5 to 2 times by mass of water is added to the mass of the germinated soybean, and grinding is carried out once to twice with a Mass Colloider while adjusting the slit width, thereby producing bean slurry. The enzyme-inactivation-untreated germinated whole grain soymilk can be produced by subjecting thus obtained bean slurry to a treatment with a homogenizer at a pressure of preferably 5 to 50 MPa, more preferably 10 to 40 MPa, and most preferably 15 to 30 MPa.

In addition, the enzyme-inactivation-treated germinated whole grain soymilk can be produced by an enzyme-inactivating treatment, specifically, by heating at a temperature of preferably 100 to 150° C., more preferably 110 to 140° C., and most preferably 110 to 135° C. for preferably 1 sec to 1 minute, more preferably 2 sec to 30 sec, and most preferably 2 sec to 10 sec with a UHT sterilizer, following the treatment with a homogenizer.

In the present invention, any one of the enzyme-inactivation-untreated germinated soymilk, the enzyme-inactivation-treated germinated soymilk, the enzyme-inactivation-untreated germinated whole grain soymilk, or the enzyme-inactivation-treated germinated whole grain soymilk can be used; however, in order to achieve a more favorable effect of improving the flavor, it is preferred to use the enzyme-inactivation-untreated germinated soymilk, or the enzyme-inactivation-untreated germinated whole grain soymilk.

Next, the method for producing the germinated whole fat soybean powder from the germinated soymilk, or the germinated whole grain soymilk is explained, but the germinated whole fat soybean powder which can be used in the present invention is not limited to the product obtained by the following production method.

The germinated whole fat soybean powder can be produced by subjecting the germinated soymilk, or the germinated whole grain soymilk to a drying treatment. For the method of drying, a freeze-drying process, a hot-air drying process, a spray drying process or the like can be used. Particularly, the freeze-drying process and the spray drying process are preferred.

The drying condition for the freeze-drying process may involve a preset temperature on the shelf of preferably 10 to 60° C., more preferably 20 to 40° C., and most preferably 25 to 35° C. Furthermore, the degree of vacuum is preferably no greater than 0.4 kPa, more preferably no greater than 0.3 kPa, and most preferably no greater than 0.25 kPa.

The drying condition for the hot-air drying process may involve a temperature of hot air of preferably 40 to 75° C., more preferably 50 to 70° C., and most preferably 60 to 70° C. Moreover, the drying time is preferably 30 min to 72 hrs, more preferably 3 to 48 hrs, and most preferably 6 to 18 hrs.

The drying condition for the spray drying process may involve a preset temperature at the inlet of 130° C. to 180° C., more preferably 150 to 180° C., and most preferably 160 to 180° C. Moreover, the preset temperature at the outlet is preferably 50 to 80° C., more preferably 60 to 80° C., and most preferably 70 to 80° C.

Next, enzyme-inactivation-untreated ungerminated whole fat soybean powder (C) is explained. The enzyme-inactivation-untreated ungerminated whole fat soybean powder (C) refers to soybean powder subjected to neither the enzyme-inactivating treatment nor a defatting treatment (ungerminated whole fat soybean powder), and a commercialized product can be used. Examples of the commercialized product include an article of trade “Soya Flour NSA” manufactured by Nisshin OilliO Group, Ltd., and the like.

A method for producing the enzyme-inactivation-untreated ungerminated whole fat soybean powder (C) is explained below by way of examples, but the enzyme-inactivation-untreated ungerminated whole fat soybean powder (C) that can be used the present invention is not limited to the product obtained by the following production method.

The soybean is dried by hot air at preferably 40 to 70° C., more preferably 50 to 70° C., and most preferably 60° C. to 70° C., for preferably 1 hour to 72 hrs, more preferably 6 hrs to 48 hrs, and most preferably 12 hrs to 18 hrs to produce dried soybean. The enzyme-inactivation-untreated ungerminated whole fat soybean powder (C) can be produced by grinding thus resulting dried soybean with a grinder mill such as a hammer mill, jet mill, bead mill, or the like. Herein, when just the term “soybean” is merely described, the “ungerminated soybean” is indicated.

The enzyme-inactivation-untreated ungerminated whole fat soybean powder (C) can be produced by subjecting the enzyme-inactivation-untreated soymilk, or the enzyme-inactivation-untreated whole grain soymilk to a drying treatment. For the method of drying, a freeze-drying process, a hot-air drying process, a spray drying process or the like can be used. Particularly, the freeze-drying process and the spray drying process are preferred. Herein, when just the term “soymilk” or “whole grain soymilk” is merely described, “a soymilk produced from ungerminated bean as a raw material” or “a whole grain soymilk produced from ungerminated bean as a raw material” is indicated, respectively.

Meanwhile, the soybean is soaked in water adjusted to 10 to 60° C., more preferably 20 to 40° C., and most preferably 20 to 30° C. for preferably 1 to 24 hrs, more preferably 2 to 12 hrs, and most preferably 3 to 6 hrs, followed by dewetting to obtain soaked soybean. The amount of water used in soaking is preferably 2 to 5 times by mass of the soybean. After adding to the soaked soybean: water in an amount of 2 to 5 times by mass of the resulting soaked soybean, grinding is carried out two times with a Mass Colloider (manufactured by Masuko Sangyo Co., Ltd.) to produce bean slurry. The enzyme-inactivation-untreated ungerminated whole fat soybean powder (C) can be produced by treating thus obtained bean slurry with a homogenizer at a pressure of preferably 5 to 50 MPa, and thereafter drying by a spray drying process (preset temperature at the inlet: 140 to 180° C., preset temperature at the outlet: 50 to 70° C.).

The content of the germinated whole fat soybean powder or the enzyme-inactivation-untreated ungerminated whole fat soybean powder (C) in the flavor improving agent of the present invention is preferably 50% by mass to 100% by mass, more preferably 80 to 100% by mass, still more preferably 90 to 100% by mass, and most preferably 100% by mass. Here, when the content is 100% by mass, the germinated whole fat soybean powder or the enzyme-inactivation-untreated ungerminated whole fat soybean powder (C) can be directly used for improving the flavor of a food, thereby leading to an advantage of being capable of achieving the effect of improving the flavor of the food with a small amount added.

Additionally, when both the germinated whole fat soybean powder and the enzyme-inactivation-untreated ungerminated whole fat soybean powder (C) are included, their total amount is preferably 50% by mass to 100% by mass, more preferably 80 to 100% by mass, still more preferably 90 to 100% by mass, and most preferably 100% by mass in the flavor improving agent. Here, when the content is 100% by mass, the germinated whole fat soybean powder and the enzyme-inactivation-untreated ungerminated whole fat soybean powder (C) can be directly used for improving the flavor of a food, thereby leading to an advantage of being capable of achieving the effect of improving the flavor of the food with a small amount added.

Starch, dextrin, saccharide, amino acid, lecithin and the like can be added to the flavor improving agent of the present invention. When these additives are included, the amount is preferably 0.01% by mass to 50% by mass, more preferably 0.1 to 20% by mass, and still more preferably 0.1 to 10% by mass in the flavor improving agent.

Next, the food in which the flavor improving agent of the present invention is used is explained. The flavor improving agent of the present invention can be used in food such as soybean protein, enzyme-inactivation-treated ungerminated whole fat soybean powder (a), enzyme-inactivation-treated ungerminated defatted soybean powder (b), enzyme-inactivation-untreated ungerminated defatted soybean powder (c), soybean processed food, wheat protein, wheat flour, wheat flour processed food, milk protein, dairy product, processed marine product, and processed livestock product. Among these, when it is added to a food containing soybean as a main component, such as soybean protein, soymilk, soybean beverages, bean curd (may be referred to as “tofu”), bean curd skin (may be referred to as “yuba”), sweet bean curd, and soybean yoghurt, in particular, a more favorable effect of improving the flavor can be exhibited.

The method for producing a food having an improved flavor is now explained. First, the method for producing a food having an improved flavor by adding the enzyme-inactivation-treated germinated whole fat soybean powder (A) is explained. The food having an improved flavor can be produced by either adding directly to the food (e1), or adding to an intermediary material of the food (e2) in the production step of such a food. It is preferred that the enzyme-inactivation-treated germinated whole fat soybean powder (A) be added to the food (e1) or the intermediary material of a food in a production step of the food (e2), preferably in an amount accounting for 0.1 to 20% by mass of the solid content of the food (e1) or the solid content of the intermediary material of the food (e2).

Moreover, the amount of the added soybean powder is more preferably 1 to 10% by mass of the solid content of the food (e1) or the solid content of the intermediary material of the food (e2), and most preferably 1 to 5% by mass of the solid content of the food (e1) or the solid content of the intermediary material of the food (e2).

Next, the method for producing a food having an improved flavor by adding at least one kind of soybean powder selected from the enzyme-inactivation-untreated germinated whole fat soybean powder (B), and the enzyme-inactivation-untreated ungerminated whole fat soybean powder (C) is explained. The food having an improved flavor can be produced by: adding to the food (e1), or the intermediary material of a food in a production step of the food (e2): at least one kind of soybean powder selected from the enzyme-inactivation-untreated germinated whole fat soybean powder (B), and the enzyme-inactivation-untreated ungerminated whole fat soybean powder (C) in an amount accounting for 0.1 to 20% by mass of the solid content of the food (e1) or the solid content of the intermediary material of the food (e2); keeping in the presence of moisture for preferably 10 min to 30 hrs, more preferably 10 min to 24 hrs, still more preferably 30 min to 12 hrs, and most preferably 30 min to 2 hrs; and then carrying out an enzyme-inactivating treatment.

The amount of the added soybean powder is more preferably 1 to 10% by mass of the solid content of the food (e1), or the intermediary material of a food in a production step of the food (e2), and most preferably 1 to 5% by mass of the solid content of the food (e1), or the intermediary material of a food in a production step of the food (e2).

Next, the method of using the flavor improving agent of the present invention is explained. In the method of using the flavor improving agent of the present invention, the agent can be used by adding directly to the food (e1) or by adding to the intermediary material of the food (e2) in the production step of the food. The enzyme-inactivation-treated germinated whole fat soybean powder (A) can be used by adding to the food (e1), or the intermediary material of the food in a production step of the food (e2), preferably in an amount accounting for 0.1 to 20% by mass of the solid content of the food (e1) or the solid content of the intermediary material of the food (e2). In addition, the amount added is more preferably 1 to 10% by mass of the solid content of the food (e1) or the solid content of the intermediary material of the food (e2), and most preferably 1 to 5% by mass of the solid content of the food (e1) or the solid content of the intermediary material of the food (e2).

In this procedure, the amount of 0.1 to 20% by mass is preferred because the effect of improving the flavor cannot be expected when it is added in an amount of less than 0.1% by mass. Although addition in an amount of more than 20% by mass is permitted, a more favorable effect of improving the flavor can hardly be expected than the case of addition at 20% by mass.

Furthermore, the solid content of the food (e1) can be measured by a drying loss method, and specifically, 15 g of the food may be dried at 105° C. for 6 hrs, whereby the solid content can be determined from the resulting dry mass.

In addition, the solid content of the intermediary material of the food (e2) can be measured by a drying loss method, and specifically, 15 g of the intermediary material of the food may be dried at 105° C. for 6 hrs, whereby the solid content can be determined from the resulting dry mass.

The enzyme-inactivation-untreated germinated whole fat soybean powder (B) and enzyme-inactivation-untreated ungerminated whole fat soybean powder (C) can be also used by adding to the food (e1) or the intermediary material of a food in a production step of the food (e2) in an amount accounting for preferably 0.1 to 20% by mass of the solid content of the food (e1) or the solid content of the intermediary material of the food (e2). In order to achieve a more favorable effect of improving the flavor, it is preferable, after adding to the food (e1) or to the intermediary material of a food in a production step of the food (e2), to keep in the presence of moisture for 10 min to 30 hrs, and thereafter enzyme-inactivating treatment is carried out. In addition, the amount added is more preferably 1 to 10% by mass of the solid content of the food (e1), or the solid content of the intermediary material of the food (e2), and most preferably 1 to 5% by mass of the solid content of the food (e1) or the solid content of the intermediary material of the food (e2).

In this procedure, the amount of 0.1 to 20% by mass is preferred because the effect of improving the flavor cannot be expected when it is added in an amount of less than 0.1% by mass. Although addition in an amount of more than 20% by mass is permitted, a more favorable effect of improving the flavor can hardly be expected than the case of addition at 20% by mass. When the flavor improving agent of the present invention is directly added to the food, the food is preferably a powder or liquid in order to homogenously mix the flavor improving agent in the food.

Examples of the soybean protein include defatted soybean produced by defatting soybean, soybean protein extract prepared by removing bean curd refuse from the defatted soybean, concentrated soybean protein produced by concentrating protein and bean curd refuse from the defatted soybean, separated soybean protein produced by separating protein from the defatted soybean, particulate protein produced by pressurizing poorly denatured defatted soybean to be swollen, and the like, and a commercial product can be used. The soybean protein that can be used may be either powdery or granular, and may be either enzyme-inactivation-treated or not subjected to an enzyme-inactivating treatment.

Examples of the commercial product of the defatted soybean protein include an article of trade “Solpy NY” manufactured by Nisshin OilliO Group, Ltd., which is an enzyme-inactivation-treated powdery separated soybean protein, an article of trade “Solpy 600” manufactured by Nisshin OilliO Group, Ltd., which is an enzyme-inactivation-treated powdery concentrated soybean protein, “Solpy 4000” manufactured by Nisshin OilliO Group, Ltd., which is an enzyme-inactivation-treated powdery separated soybean protein, and the like.

The flavor improving agent of the present invention can be added directly to these soybean proteins, or the flavor improving agent of the present invention can be added during production of the soybean protein. For example, in the case of separated soybean protein, the protein may be precipitated with acid to separate the protein, which is then dissolved in water. Thereafter, the pH is adjusted to prepare a protein-containing solution to which the flavor improving agent of the present invention is added, thereby completing production.

The enzyme-inactivation-treated ungerminated whole fat soybean powder (a) is obtained by powdering ungerminated soybean, followed by an enzyme-inactivating treatment to have a lipoxygenase activity of 0 units, and a commercial product can be used. The commercial product may be, for example, “Soya Flour HS-700” and “Soya Flour alpha plus HS-600” manufactured by Nisshin OilliO Group, Ltd., which are whole fat soybean powders, and “New Soyme” manufactured by Nisshin OilliO Group, Ltd., which is particulate protein, and the like.

The enzyme-inactivation-treated ungerminated defatted soybean powder (b) is obtained by defatting, and then powdering ungerminated soybean, followed by an enzyme-inactivating treatment to have a lipoxygenase activity of 0 units, and a commercial product can be used. The commercialized product may be, for example, defatted soybean manufactured by Showa Sangyo Co., Ltd., and the like.

The enzyme-inactivation-untreated ungerminated defatted soybean powder (c) is obtained by defatting ungerminated soybean, followed by powdering, and a commercial product can be used. The commercial product may be, for example, “Soya Flour A” manufactured by Nisshin OilliO Group, Ltd., which is powdery poorly denatured defatted soybean not subjected to an enzyme-inactivating treatment (ungerminated defatted soybean powder), and the like.

The method for producing soybean powder having an improved flavor to which the enzyme-inactivation-treated germinated whole fat soybean powder (A) is added is now explained. The soybean powder having an improved flavor of the present invention can be produced by adding to at least one kind of soybean powder selected from the enzyme-inactivation-treated ungerminated whole fat soybean powder (a), the enzyme-inactivation-treated ungerminated defatted soybean powder (b), and the enzyme-inactivation-untreated ungerminated defatted soybean powder (c): the enzyme-inactivation-treated germinated whole fat soybean powder (A) in an amount accounting for 0.1 to 20% by mass of the amount of the soybean powder, and mixing.

As this enzyme-inactivation-treated germinated whole fat soybean powder (A), any one of the above-referenced products, i.e., one produced by powdering a germinated soybean and subjecting to an enzyme-inactivating treatment; one produced by powdering an enzyme-inactivation-treated germinated soymilk; and one obtained by powdering an enzyme-inactivation-treated germinated whole grain soymilk can be used.

Next, a method for producing soybean powder having an improved flavor to which the enzyme-inactivation-untreated germinated whole fat soybean powder (B) is added is explained. The soybean powder having an improved flavor of the present invention can be produced by a production method including steps of: (1) bringing at least one kind of soybean powder selected from enzyme-inactivation-treated ungerminated whole fat soybean powder (a), enzyme-inactivation-treated ungerminated defatted soybean powder (b), and enzyme-inactivation-untreated ungerminated defatted soybean powder (c) into contact with the enzyme-inactivation-untreated germinated whole fat soybean powder (B) in an amount accounting for 0.1 to 20% by mass of the amount of the soybean powder in the presence of moisture for preferably 10 min to 30 hrs, more preferably 10 min to 24 hrs, still more preferably 30 min to 12 hrs, and most preferably 30 min to 2 hrs; (2) carrying out an enzyme-inactivating treatment; and (3) carrying out a drying treatment.

The amount of addition in this step is more preferably 1 to 10% by mass, and most preferably 1 to 5% by mass of the amount of at least one kind of soybean powder selected from the enzyme-inactivation-treated ungerminated whole fat soybean powder (a), the enzyme-inactivation-treated ungerminated defatted soybean powder (b), the enzyme-inactivation-untreated ungerminated defatted soybean powder (c).

Step (1) may include, specifically, the steps of: adding to at least one kind of soybean powder selected from the enzyme-inactivation-treated ungerminated whole fat soybean powder (a), the enzyme-inactivation-treated ungerminated defatted soybean powder (b), and the enzyme-inactivation-untreated ungerminated defatted soybean powder (c): the enzyme-inactivation-untreated germinated whole fat soybean powder (B) in an amount accounting for 0.1 to 20% by mass of the amount of the soybean powder, and mixing therewith; adding water thereto; and keeping for 10 min to 30 hrs. In this case, the amount of added water is preferably 20 to 90% by mass, more preferably 20 to 70% by mass, and most preferably 20 to 50% by mass of total powder mass.

Alternatively, steps including: adding the enzyme-inactivation-untreated germinated whole fat soybean powder (B) in an amount accounting for 0.1 to 20% by mass of the amount of the enzyme-inactivation-treated ungerminated whole fat soybean powder (a), and the enzyme-inactivation-treated ungerminated whole fat soybean powder into water to prepare an aqueous solution containing soybean powder; and keeping the thus resulting aqueous solution for 10 min to 30 hrs may be exemplified. In this case, water is preferably used in an amount of 5 to 10 times the total mass of added soybean powder.

As this enzyme-inactivation-untreated germinated whole fat soybean powder (B), any one of the above-referenced products, i.e., one produced by powdering the germinated soybean not subjected to an enzyme-inactivating treatment; one produced by powdering the enzyme-inactivation-untreated germinated soymilk, and one produced by powdering the enzyme-inactivation-untreated germinated whole grain soymilk can be used.

Step (2) may include, specifically, the above-referenced enzyme-inactivating treatment, i.e., a treatment to give a lipoxygenase activity of 0 units, and for example, an enzyme-inactivating treatment by heating, and an enzyme-inactivating treatment by adding a reagent may be exemplified.

The heating temperature in the enzyme-inactivating treatment by heating is preferably 80° C. to 150° C., preferably 80 to 120° C., and most preferably 100 to 120° C. Furthermore, the heating time period is preferably 1 sec to 6 hrs, more preferably 3 sec to 3 hrs, and most preferably 3 sec to 1 hour.

When a solid is treated, a specific method of the enzyme-inactivating treatment may include heating at a temperature of preferably 80 to 150° C., more preferably 80 to 120° C., and most preferably 100 to 120° C. for preferably 1 sec to 6 hrs, more preferably 3 sec to 1 hour, and most preferably 5 sec to 1 hour using hot air, steam or the like.

In addition, when a liquid is treated, a method of heating at a temperature of preferably 100 to 150° C., more preferably 110 to 140° C., and most preferably 110 to 135° C. for preferably 1 sec to 1 minute, more preferably 2 sec to 30 sec, and most preferably 2 sec to 10 sec using a UHT sterilizer may be exemplified.

Step (3) may include, specifically, the above-referenced drying process, i.e., conducting a drying treatment of soybean powder by a freeze-drying process, a hot-air drying process, a spray drying process or the like. When a solid is to be dried, the hot-air drying process is preferably used, while a freeze-drying process or a spray drying process is preferably used when a liquid is to be dried.

The drying condition for the freeze-drying process may involve a preset temperature on the shelf of preferably 10 to 60° C., more preferably 20 to 40° C., and most preferably 25 to 35° C. Furthermore, the degree of vacuum is preferably no greater than 0.4 kPa, more preferably no greater than 0.3 kPa, and most preferably no greater than 0.25 kPa.

The drying conditions for the hot-air drying process may involve a temperature of hot air of preferably 40 to 75° C., more preferably 50 to 70° C., and most preferably 60 to 70° C. Moreover, the drying time is preferably 30 min to 72 hrs, more preferably 3 to 48 hrs, and most preferably 6 to 18 hrs.

The drying condition for the spray drying process may involve a preset temperature at the inlet of 130 to 180° C., more preferably 150 to 180° C., and most preferably 160 to 180° C. Moreover, the preset temperature at the outlet is preferably 50 to 80° C., more preferably 60 to 80° C., and most preferably 70 to 80° C.

In one example of the production method including all of steps (1), (2) and (3), 1.9 kg of enzyme-inactivation-treated ungerminated whole fat soybean powder (a), and 0.1 kg of enzyme-inactivation-untreated germinated whole fat soybean powder (B) are added to 10 kg of water to prepare an aqueous solution containing soybean powder, and the thus resulting aqueous solution is kept at 25° C. for 2 hrs. Next, the enzyme is inactivated by heating the aqueous solution containing soybean powder at 130° C. for 5 sec using a UHT sterilizer. Finally, the enzyme-inactivation-treated aqueous solution containing soybean powder is dried by a spray drying process (preset temperature at the inlet: 180° C., preset temperature at the outlet: 75° C.), whereby a soybean powder having an improved flavor can be produced.

Next, the method for producing soybean powder having an improved flavor to which the enzyme-inactivation-untreated ungerminated whole fat soybean powder (C) was added is explained. The soybean powder having an improved flavor of the present invention can be produced by a production method including steps of: (1) bringing at least one kind of soybean powder selected from enzyme-inactivation-treated ungerminated whole fat soybean powder (a), enzyme-inactivation-treated ungerminated defatted soybean powder (b), and enzyme-inactivation-untreated ungerminated defatted soybean powder (c) into contact with the enzyme-inactivation-untreated ungerminated whole fat soybean powder (C) in an amount accounting for 0.1 to 20% by mass of the amount of the soybean powder in the presence of moisture for preferably 10 min to 30 hrs, more preferably 10 min to 24 hrs, still more preferably 30 min to 12 hrs, and most preferably 30 min to 2 hrs; (2) carrying out an enzyme-inactivating treatment; and (3) carrying out a drying treatment.

In this step, the amount of addition is more preferably 1 to 10% by mass, and most preferably 1 to 5% by mass of the amount of at least one kind of soybean powder selected from the enzyme-inactivation-treated ungerminated whole fat soybean powder (a), the enzyme-inactivation-treated ungerminated defatted soybean powder (b), the enzyme-inactivation-untreated ungerminated defatted soybean powder (c).

Step (1) may include, specifically, the steps of: adding to at least one kind of soybean powder selected from the enzyme-inactivation-treated ungerminated whole fat soybean powder (a), the enzyme-inactivation-treated ungerminated defatted soybean powder (b), and the enzyme-inactivation-untreated ungerminated defatted soybean powder (c): the enzyme-inactivation-untreated ungerminated whole fat soybean powder (C) in an amount accounting for 0.1 to 20% by mass of the amount of the soybean powder, and mixing therewith; adding water thereto; and keeping for 10 min to 30 hrs. In this case, the amount of added water is preferably 20 to 90% by mass, more preferably 20 to 70% by mass, and most preferably 20 to 50% by mass of total powder mass.

Alternatively, the steps including: adding the enzyme-inactivation-untreated ungerminated whole fat soybean powder (C) in an amount accounting for 0.1 to 20% by mass of the amount of the enzyme-inactivation-treated ungerminated whole fat soybean powder (a), and the enzyme-inactivation-treated ungerminated whole fat soybean powder into water to prepare an aqueous solution containing soybean powder; and keeping the thus resulting aqueous solution for 10 min to 30 hrs may be exemplified. In this case, water is preferably used in an amount of 5 to 10 times the total mass of added soybean powder.

As this enzyme-inactivation-untreated ungerminated whole fat soybean powder (C) in this step, any one of the above-referenced products, i.e., one produced by powdering the soybean not subjected to an enzyme-inactivating treatment; one produced by powdering the enzyme-inactivation-untreated soymilk, and one produced by powdering the enzyme-inactivation-untreated whole grain soymilk can be used.

Steps (2) and (3) are the same as steps (2) and (3) in the method for producing a soybean powder having an improved flavor in which the enzyme-inactivation-untreated germinated whole fat soybean powder (B) is used as a raw material as explained above.

In one example of the production method including all of the steps (1), (2) and (3), 1.8 kg of enzyme-inactivation-treated ungerminated whole fat soybean powder (a), and 0.2 kg of enzyme-inactivation-untreated ungerminated whole fat soybean powder (C) are added to 10 kg of water to prepare an aqueous solution containing soybean powder, and the thus resulting aqueous solution is kept for 1 hour. Next, the enzyme is inactivated by heating the aqueous solution containing soybean powder at 140° C. for 3 sec using a UHT sterilizer. Finally, the enzyme-inactivation-treated aqueous solution containing soybean powder is dried by a spray drying process (preset temperature at the inlet: 175° C., preset temperature at the outlet: 70° C.), whereby a soybean powder having an improved flavor can be produced.

Additionally, in a method for producing particulate protein TSP to which the flavor improving agent of the present invention (enzyme-inactivation-untreated ungerminated whole fat soybean powder (C)) is added, the enzyme-inactivation-untreated ungerminated whole fat soybean powder (C) in a amount of 5% by mass of the soybean powder mass is added to the soybean powder before the step of heating while applying pressure in an extruder upon adding 20 to 50% by mass of water, keeping for 1 hour, followed by an enzyme-inactivating treatment in an extruder (temperature: 150 to 170° C., 12 to 15 kg/cm², 40 to 50 sec) followed by a drying treatment with a hot-air dryer (temperature: 100° C.).

In addition, in a method for producing separated soybean protein to which the flavor improving agent of the present invention (enzyme-inactivation-untreated ungerminated whole fat soybean powder (C)) is added, after precipitating soybean protein with an acid to allow for separation, the separated matter is washed, and the thus resulting separated matter is dissolved in water. After neutralizing the pH of the thus prepared aqueous solution, the enzyme-inactivation-untreated ungerminated whole fat soybean powder (C) in an aqueous solution having the solid content of 0.1 to 20% by mass is added thereto, and kept for 2 hrs. Thereafter, a drying treatment is carried out by a spray drying process (preset temperature at the inlet: 175° C., preset temperature at the outlet: 70° C.).

The soybean processed food refers to a food in which soybean is used as a main ingredient, and specific examples include soymilk, whole grain soymilk, soybean beverages, bean curd, bean curd skin, fried bean curd mixed with sliced vegetables, soybean yoghurt, and sweet bean curd and the like. A commercial product can be used as such a food.

A method for producing a soymilk and a whole grain soymilk having an improved flavor is now explained. The soymilk having an improved flavor can be produced by adding to a solution obtained by removing bean curd refuse from a bean slurry obtained by grinding soybean: the enzyme-inactivation-untreated germinated whole fat soybean powder (B), or the enzyme-inactivation-untreated ungerminated whole fat soybean powder (C), in an amount accounting for 0.1 to 20% by mass of the solid content of the solution during the production step of the soymilk, keeping for preferably 10 min to 30 hrs, more preferably 10 min to 24 hrs, still more preferably 30 min to 12 hrs, and most preferably 30 min to 2 hrs, and thereafter carrying out an enzyme-inactivating treatment. In this case, the solution prepared by removing bean curd refuse falls under the intermediary material of the food (e2).

The amount of addition accounts for more preferably 1 to 10% by mass, and most preferably 1 to 5% by mass of the solid content of the solution prepared by bean curd refuse.

Specifically, the soymilk to which the flavor improving agent of the present invention (enzyme-inactivation-untreated germinated whole fat soybean powder (B) or enzyme-inactivation-untreated ungerminated whole fat soybean powder (C)) is added can be produced as by the following. Soybean is soaked in water at room temperature for 12 hrs to produce soaked soybean. To 10 kg of the thus resulting soaked soybean is added 20 kg of water, i.e., two times the mass of the soaked soybean, and then subjected to a grinding treatment twice with a Mass Colloider (manufactured by Masuko Sangyo Co., Ltd.), whereby bean slurry is produced. In this procedure, it is preferred that the slit width of the Mass Colloider in the second grinding treatment be predetermined as half of that in the first treatment. The thus obtained bean slurry is subjected to a centrifugal separation treatment (condition: 1500 rpm) to remove the bean curd refuse, whereby the intended solution is obtained. Subsequently, to the solution obtained by removing the bean curd refuse is added the flavor improving agent of the present invention in an amount accounting for 0.1 to 20% by mass of the solid content, and allowed to stand still at 25° C. for 3 hrs. Thereafter, the enzyme-inactivating treatment is carried out at 140° C. for 2 sec with a UHT sterilizer to produce the soymilk. In this case, the solution obtained by removing bean curd refuse falls under the intermediary material of the food (e2).

The whole grain soymilk having an improved flavor can be produced by adding to the bean slurry obtained by grinding soybean: the enzyme-inactivation-untreated germinated whole fat soybean powder (B), or the enzyme-inactivation-untreated ungerminated whole fat soybean powder (C) in an amount accounting for 0.1 to 20% by mass of the solid content of the bean slurry during the production step of the whole grain soymilk, keeping for preferably 10 min to 30 hrs, more preferably 10 min to 24 hrs, still more preferably 30 min to 12 hrs, and most preferably 30 min to 2 hrs, and thereafter carrying out an enzyme-inactivating treatment. In this case, the bean slurry obtained by grinding soybean falls under the intermediary material of the food (e2).

The amount of addition accounts for more preferably 1 to 10% by mass, and most preferably 1 to 5% by mass of the solid content of the bean slurry.

Specifically, the whole grain soymilk to which the flavor improving agent of the present invention (enzyme-inactivation-untreated germinated whole fat soybean powder (B) or enzyme-inactivation-untreated ungerminated whole fat soybean powder (C)) is added can be produced as by the following. Soybean is soaked in water at room temperature for 12 hrs to produce soaked ungerminated soybean. To 10 kg of the thus resulting soaked soybean is added 20 kg of water, i.e., two times the mass of the soaked soybean, and then subjected to a grinding treatment twice with a Mass Colloider (manufactured by Masuko Sangyo Co., Ltd.), whereby bean slurry is produced. After homogenizing the thus resulting bean slurry by subjecting to a homogenizer treatment at a pressure of 15 MPa, to the bean slurry is added the flavor improving agent of the present invention in an amount accounting for 10% by mass of the solid content, and allowed to stand still at 25° C. for 3 hrs. Thereafter, the enzyme-inactivating treatment is carried out at 140° C. for 2 sec with a UHT sterilizer to produce the whole grain soymilk. In this case, the bean slurry obtained through homogenization by a homogenizer treatment at a pressure of 15 MPa falls under the intermediary material of the food (e2).

The soymilk, or the whole grain soymilk having an improved flavor can also be produced by adding to the soymilk (d1) or the whole grain soymilk (d2): the enzyme-inactivation-untreated germinated whole fat soybean powder (B), or the enzyme-inactivation-untreated ungerminated whole fat soybean powder (C) in an amount accounting for 0.1 to 20% by mass of the soymilk (d1) or the whole grain soymilk (d2), keeping for preferably 10 min to 30 hrs, more preferably 10 min to 24 hrs, still more preferably 30 min to 12 hrs, and most preferably 30 min to 2 hrs, and thereafter carrying out an enzyme-inactivating treatment.

The amount of addition accounts for more preferably 1 to 10% by mass, and most preferably 1 to 5% by mass of the solid content of the soymilk (d1) or the whole grain soymilk (d2).

Specifically, the soymilk or the whole grain soymilk to which the flavor improving agent of the present invention (enzyme-inactivation-untreated germinated whole fat soybean powder (B) or enzyme-inactivation-untreated ungerminated whole fat soybean powder (C)) is added can be produced as by the following. To the soymilk (d1), or the whole grain soymilk (d2) is added the flavor improving agent of the present invention (enzyme-inactivation-untreated germinated whole fat soybean powder (B) or enzyme-inactivation-untreated ungerminated whole fat soybean powder (C)) in an amount accounting for 10% by mass of the solid content of the soymilk (d1) or the whole grain soymilk (d2), and allowed to stand still at 25° C. for 3 hrs. Thereafter, the enzyme-inactivating treatment is carried out at 85° C. for 15 min to produce the soymilk or the whole grain soymilk.

In a method for producing bean curd including adding the flavor improving agent of the present invention during the production of the bean curd, for example, the flavor improving agent of the present invention may be added after separating the bean curd refuse from the bean slurry.

Wheat protein is obtained by subjecting wheat flour to a treatment such as kneading, washing/washing with water and the like, and a commercial product can be used. Examples of the commercial product include, an article of trade “A-Glu (wheat protein)” manufactured by Glico Foods Co., Ltd., an article of trade “Vital Gluten (wheat protein)” manufactured by Hokkoku Food Kabushiki Kaisya, and the like.

In a method for producing wheat protein including adding the flavor improving agent of the present invention during the production of the wheat protein, for example, the addition may be conducted in the step following the step of kneading a mixture obtained by adding water to wheat flour, i.e., in the step of pasting, mixing, dispersing and the like. A commercial product can be used as the wheat flour. In a method for producing wheat protein including adding the flavor improving agent of the present invention during the production of wheat flour, for example, the addition may be conducted during grinding.

The wheat flour processed food is obtained by the processing of wheat flour as a main component, and a commercial product can be used. Examples of the commercial product include an article of trade “rouleau de printemps skin for business use (Gyomu-you Harumaki kawa)” manufactured by Sanritsu Syokuhin Kabushiki Kaisya, jiao-zi dumpling skin manufactured by Nishiyama Seimen. Inc., an article of trade “Love Spread” (pain de mie) manufacture by First Baking Co., Ltd. and the like. In a method for producing jiao-zi dumpling skin including adding the flavor improving agent of the present invention during the production of the jiao-zi dumpling skin, for example, the addition may be conducted during the step of adding water to wheat flour, and kneading.

The milk protein is obtained by subjecting cow's milk to a treatment with an acid to allow for precipitation, which is then separated, and a commercial product can be used. Examples of the commercial product include, for example, Milka manufactured by Nippon Shinyaku Co., Ltd., Pure Isolate manufactured by Fine Lab Co., Ltd, and the like. In a method for producing milk protein including adding the flavor improving agent of the present invention to the milk protein, for example, the addition may be conducted during resolubilization after separating the protein from cow's milk by precipitation with an acid.

The dairy product refers to, specifically, cow's milk, yoghurt, cream, whole powdered milk, defatted concentrated milk, milk powder, whey powder, casein phosphopeptide powder, a milk beverage and the like. A commercial product can be used as such products. In a method for producing the dairy product including adding the flavor improving agent of the present invention, for example, the addition of the flavor improving agent of the present invention may be conducted before inoculating lactic acid bacterium to cow's milk during the production of yoghurt. In addition, a method for producing milk powder including adding the flavor improving agent of the present invention before powdering the flavor improving agent of the present invention by a spray drying process may also be exemplified.

Examples of the processed marine product include steamed fish paste (Kamaboko), deep-fried minced fish (Satsuma-age), minced and steamed fish (Hanpen), baked tubular fish paste (Chikuwa), minced fillet of cod, minced fish ball, naruto and the like. A commercial product can be used as such products. In a method for producing the processed marine product including adding the flavor improving agent of the present invention, for example, the addition may be conducted in the step of preparing minced fish by mincing fish flesh after cutting the fish to divide into the flesh, skin and bone.

Examples of the processed livestock product include processed meat products such as salami, ham, sausage, corned beef and the like. A commercial product can be used as such products. In a method for producing the processed livestock product including adding the flavor improving agent of the present invention, for example, the addition may be conducted following chopping the livestock meat with a chopper, and before the production step with salt, sugar or the like during the production step of sausage.

Moreover, the flavor improving agent of the present invention can be used by adding to a health-food such as SOD (superoxide dismutase), turmeric, phycodin, soybean peptide and the like. In a method for producing the health-food including adding the flavor improving agent of the present invention, for example, the addition may be conducted during extraction, purification, granulation, tablet making of a material for the health-food such as turmeric; or the addition may be conducted when the soybean peptide is added to the beverage.

### EXAMPLES

Hereinafter, the present invention is explained in more detail by Examples, but the present invention is not limited thereto.

### Production Example 1

### Production of Germinated Soybean

After washing 10 kg of soybean (sold by Nisshin shokai Co., Ltd., trade name “Enrei”) twice with water, 50 kg, i.e., five times the mass of the soybean, of water was added to carry out soaking at 30° C. for 3 hrs. Thereafter, while controlling the temperature at 25° C., showering water from above for 10 min once per hour was repeated for 18 hrs to produce the germinated soybean. During the soaking, germination was promoted by bubbling 5000 mL of air per minute. The thus resulting germinated soybean had a germination percentage of 95%.

### Production Example 2

### Production of Enzyme-Inactivation-Untreated Germinated Whole Fat Soybean Powder (B)

To 10 kg of the germinated soybean obtained in a similar manner to Production Example 1 was added 20 kg, i.e., two times the mass of the germinated soybean, of water, and then was subjected to a grinding treatment twice with a Mass Colloider (manufactured by Masuko Sangyo Co., Ltd.) to obtain bean slurry. Here, the slit width of the Mass Colloider in the second treatment was predetermined as half of that in the first treatment. The thus resulting bean slurry was filtered by a filter press under a condition of a pressure of 0.1 to 0.5 kPa to remove bean curd refuse, whereby the enzyme-inactivation-untreated germinated soymilk was produced. The produced germinated soymilk was dried by a spray drying process (preset temperature at the inlet: 180° C., preset temperature at the outlet: 75° C.) to produce the enzyme-inactivation-untreated germinated whole fat soybean powder (B).

### Production Example 3

### Production of Enzyme-Inactivation-Treated Germinated Whole Fat Soybean Powder (A)

To 10 kg of the germinated soybean obtained in a similar manner to Production Example 1 was added 20 kg, i.e., two times the mass of the germinated soybean, of water, and then was subjected to a grinding treatment twice with a Mass Colloider (manufactured by Masuko Sangyo Co., Ltd.) to obtain bean slurry. Here, the slit width of the Mass Colloider in the second treatment was predetermined as half of that in the first treatment. After centrifugal separation (condition: 1500 rpm) of the thus resulting bean slurry to remove bean curd refuse, an enzyme-inactivating treatment was carried out with a UHT sterilizer at 130° C. for 5 sec, whereby the enzyme-inactivation-treated germinated soymilk was produced. The produced germinated soymilk was dried by a spray drying process (preset temperature at the inlet: 180° C., preset temperature at the outlet: 75° C.) to produce the enzyme-inactivation-treated germinated whole fat soybean powder (A).

### Production Example 4

### Production of Enzyme-Inactivation-Untreated Germinated Whole Fat Soybean Powder (B)

To 10 kg of the germinated soybean obtained in a similar manner to Production Example 1 was added 25 kg, i.e., 2.5 times the mass of the germinated soybean, of water, and was then subjected to a grinding treatment twice with a Mass Colloider (manufactured by Masuko Sangyo Co., Ltd.) to obtain bean slurry. Here, the slit width of the Mass Colloider in the second treatment was predetermined as half of that in the first treatment. The thus resulting bean slurry was homogenized by subjecting to a homogenizer treatment at a pressure of 15 MPa, whereby the enzyme-inactivation-untreated germinated whole grain soymilk was produced. The produced germinated whole grain soymilk was dried by a spray drying process (preset temperature at the inlet: 180° C., preset temperature at the outlet: 75° C.) to produce the enzyme-inactivation-untreated germinated whole fat soybean powder (B).

### Production Example 5

### Production of Enzyme-Inactivation-Treated Germinated Whole Fat Soybean Powder (A)

To 10 kg of the germinated soybean obtained in a similar manner to Production Example 1 was added 25 kg, i.e., 2.5 times the mass of the germinated soybean, of water, and was then subjected to a grinding treatment twice with a Mass Colloider (manufactured by Masuko Sangyo Co., Ltd.) to obtain bean slurry. Here, the slit width of the Mass Colloider in the second treatment was predetermined as half of that in the first treatment. An enzyme-inactivating treatment was carried out with a UHT sterilizer at 130° C. for 5 sec, whereby the enzyme-inactivation-treated germinated whole grain soymilk was produced. The produced germinated whole grain soymilk was dried by a spray drying process (preset temperature at the inlet: 180° C., preset temperature at the outlet: 75° C.) to produce the enzyme-inactivation-treated germinated whole fat soybean powder (A). The thus resulting enzyme-inactivation-treated germinated whole fat soybean powder (A) had a lipoxygenase activity of 0 units.

### Production Example 6

### Production of Enzyme-Inactivation-Untreated Ungerminated Whole Fat Soybean Powder (C)

Soybean (sold by Nisshin Shokai Co., Ltd., trade name “Enrei”) in an amount of 1 kg was dried by 60° C. hot air for 18 hrs. Thereafter, enzyme-inactivation-untreated ungerminated whole fat soybean powder (C) was produced by twice grinding with a hammer mill grinder.

### Production Example 7

### Production of Whole Grain Soymilk

Soybean (sold by Nisshin Shokai Co., Ltd., trade name “Enrei”) was soaked in water at room temperature for 12 hrs to produce ungerminated soaked soybean. To the thus resulting soaked soybean 10 kg was added 20 kg, i.e., two times the mass of the soaked soybean, of water, and was then subjected to a grinding treatment twice with a Mass Colloider (manufactured by Masuko Sangyo Co., Ltd.) to produce bean slurry. After homogenizing the thus resulting bean slurry by subjecting to a homogenizer treatment at a pressure of 15 MPa, an enzyme-inactivating treatment was carried out with a UHT sterilizer at 140° C. for 2 sec, whereby the whole grain soymilk was produced.

### Comparative Example 1

### Soybean Powder to which Flavor Improving Agent is not Added

To enzyme-inactivation-untreated ungerminated defatted soybean powder (c) (poorly denatured defatted soybean) (manufactured by Nisshin OilliO Group, Ltd., article of trade “Soya Flour A”) was added water in an amount of ten times the mass of the total powder mass, and allowed to stand still at 30° C. for 2 hrs, followed by an enzyme-inactivating treatment at 100° C. for 3 min. Thereafter, soybean powder was produced through a drying treatment with a spray drying process (preset temperature at the inlet: 180° C., preset temperature at the outlet: 75° C.). The produced soybean powder was added to hot water such that the concentration became 10% by mass, and was then stirred to make a sample beverage for evaluation. Evaluation on the flavor of the thus obtained sample beverage for evaluation was made according to the method described below. The evaluation results are shown in Tables 1 and 2.

### Example 1

### Test on Improvement of Flavor 1 Using Enzyme-Inactivation-Untreated Germinated Whole Fat Soybean Powder (B) (i.e., Soybean Powders B+c)

After adding to the enzyme-inactivation-untreated ungerminated defatted soybean powder (c) (poorly denatured defatted soybean) (manufactured by Nisshin OilliO Group, Ltd., article of trade “Soya Flour A”): the enzyme-inactivation-untreated germinated whole fat soybean powder (B) (powdery material: germinated soymilk) obtained in Production Example 2 in an amount accounting for 5% by mass of the ungerminated defatted soybean powder (c), water was then added in an amount of ten times the total powder mass, and allowed to stand still at 30° C. for 2 hrs. Thereafter, an enzyme-inactivating treatment was carried out at 100° C. for 3 min, followed by a drying treatment with a spray drying process (preset temperature at the inlet: 180° C., preset temperature at the outlet: 75° C.) to produce soybean powder. The produced soybean powder was added to hot water such that the concentration became 10% by mass, and then stirred to make a sample beverage for evaluation. Evaluation on the flavor of the thus obtained sample beverage for evaluation was made according to the method explained below. The evaluation results are shown in Table 1.

### Example 2

### Test on Improvement of Flavor 2 Using Enzyme-Inactivation-Untreated Germinated Whole Fat Soybean Powder (B) (i.e., Soybean Powders B+c)

In a similar manner to Example 1 except that enzyme- inactivation-untreated germinated whole fat soybean powder (B) (powdery material: germinated whole grain soymilk) obtained in Production Example 4 was used in place of the enzyme-inactivation-untreated germinated whole fat soybean powder (B) obtained in Production Example 2, soybean powder was produced. The produced soybean powder was added to hot water such that the concentration became 10% by mass, and then stirred to make a sample beverage for evaluation. Evaluation on the flavor of the thus obtained sample beverage for evaluation was made according to the method explained below. The evaluation results are shown in Table 1.

### Method for Evaluating Flavor

The sample beverage for evaluation was tasted by ten panelists to evaluate an astringent taste, and unripe smell. Thereafter, the sample beverages for evaluation made in Example 1 and Example 2 were tasted to evaluate the astringent taste, and the unripe smell. Evaluation on the flavor was made by grading into: A when neither the astringent taste nor the unripe smell was sensed; B when the sensing was unclear; and C when the astringent taste, and the unripe smell were sensed. In this flavor evaluation, the effect of improving the flavor was evaluated as positive when a majority, i.e., six or more panelists, graded with A.

TABLE 1
Table 1: Results of Test on Improvement of Flavor Using
Enzyme-inactivation-untreated Germinated Whole Fat Soybean
Powder (B)

| | | Number of | | |
|---|---|---|---|---|
| | | panelists | | |
| | | (persons) | | |
| Sample | | A | B | C |
| Comparative | Flavor Improving Agent not Added | 0 | 0 | 10 |
| Example 1 | | | | |
| Example 1 | Enzyme-inactivation-untreated | 10 | 0 | 0 |
| | germinated whole fat soybean | | | |
| | powder (powdery material: | | | |
| | germinated soymilk) obtained in | | | |
| | Production Example 2 added | | | |
| Example 2 | Enzyme-inactivation-untreated | 10 | 0 | 0 |
| | germinated whole fat soybean | | | |
| | powder (powdery material: | | | |
| | germinated whole grain soymilk) | | | |
| | obtained in Production Example 4 | | | |
| | added | | | |

As is clear from Table 1, it was revealed that the flavor was improved in the soybean powder produced by adding the enzyme-inactivation-untreated germinated whole fat soybean powder (B).

### Example 3

### Test on Improvement of Flavor 1 Using Enzyme-Inactivation-Treated Germinated Whole Fat Soybean Powder (A) (i.e., Soybean Powders A+c)

The enzyme-inactivation-treated germinated whole fat soybean powder (A) (powdery material: germinated soymilk) obtained in Production Example 3 was added to the enzyme-inactivation-untreated ungerminated defatted soybean powder (c) (poorly denatured defatted soybean) (manufactured by Nisshin OilliO Group, Ltd., an article of trade “Soya Flour A”) in an amount accounting for 5% by mass of the ungerminated defatted soybean powder (c), and then mixed to produce soybean powder. The produced soybean powder was added to hot water such that the concentration became 10% by mass, and stirred to make a sample beverage for evaluation. Evaluation on the flavor of the thus obtained sample beverage for evaluation was made according to the method explained above. The evaluation results are shown in Table 2.

### Example 4

### Test on Improvement of Flavor 2 Using Enzyme-Inactivation-Treated Germinated Whole Fat Soybean Powder (A) (i.e., Soybean Powders A+c)

The enzyme-inactivation-treated germinated whole fat soybean powder (A) (powdery material: germinated whole grain soymilk) obtained in Production Example 5 was added to the enzyme-inactivation-untreated ungerminated defatted soybean powder (c) (poorly denatured defatted soybean) (manufactured by Nisshin OilliO Group, Ltd., an article of trade “Soya Flour A”) in an amount accounting for 5% by mass of the ungerminated defatted soybean powder (c), and then mixed to produce soybean powder. The produced soybean powder was added to hot water such that the concentration became 10% by mass, and stirred to make a sample beverage for evaluation. Evaluation on the flavor of the thus obtained sample beverage for evaluation was made according to the method explained above. The evaluation results are shown in Table 2.

TABLE 2
Table 2: Results of Test on Improvement of Flavor Using
Enzyme-inactivation-treated Germinated Whole Fat Soybean
Powder (A)

| | | Number of | | |
|---|---|---|---|---|
| | | panelists | | |
| | | (persons) | | |
| Sample | | A | B | C |
| Comparative | Flavor Improving Agent not Added | 0 | 0 | 10 |
| Example 1 | | | | |
| Example 3 | Enzyme-inactivation-treated | 7 | 3 | 0 |
| | germinated whole fat soybean | | | |
| | powder (powdery material: | | | |
| | germinated soymilk) obtained in | | | |
| | Production Example 3 added | | | |
| Example 4 | Enzyme-inactivation-treated | 8 | 2 | 0 |
| | germinated whole fat soybean | | | |
| | powder (powdery material: | | | |
| | germinated whole grain soymilk) | | | |
| | obtained in Production Example 5 | | | |
| | added | | | |

As is clear from the results shown in Table 1 and Table 2, the soybean powder produced by adding the enzyme-inactivation-treated germinated whole fat soybean powder (A) also had an improved flavor; however, the effect was inferior than the soybean powder produced by adding the enzyme-inactivation-untreated germinated whole fat soybean powder (B).

### Verification Test 1: Verification Test on Amount of Added Enzyme-Inactivation-Untreated Germinated Whole Fat Soybean Powder (B)(i.e., Soybean Powders B+c)

After adding to the enzyme-inactivation-untreated ungerminated defatted soybean powder (c) (poorly denatured defatted soybean) (manufactured by Nisshin OilliO Group, Ltd., an article of trade “Soya Flour A”), the enzyme-inactivation-untreated germinated whole fat soybean powder (B) (powdery material: germinated whole grain soymilk) obtained in Production Example 4 in an amount accounting for 0.01 to 30% by weight of the ungerminated defatted soybean powder (c), water was added in an amount of ten times the total powder mass, and allowed to stand still at 30° C. for 2 hrs. Thereafter, an enzyme-inactivating treatment was carried out at 100° C. for 3 min, followed by drying with a spray drying process (preset temperature at the inlet: 180° C., preset temperature at the outlet: 75° C.), whereby soybean powders NO. 1 to NO. 8 were produced. Each of the produced soybean powders were added to hot water such that the concentration became 10% by mass, and then were stirred to make a sample beverage for evaluation. Evaluation on the flavor of the thus obtained sample beverage for evaluation was made according to the method explained above. The evaluation results are shown in Table 3. NO. 5 is identical with Example 2.

TABLE 3
Table 3: Verification Test on Amount of Added Enzyme-
inactivation-untreated Germinated Whole Fat Soybean Powder
(B) obtained in Production Example 4

| | | Number | | |
|---|---|---|---|---|
| | Amount | of panelists | | |
| | of Addition | (persons) | | |
| Sample | (% by weight) | A | B | C |
| NO. 1 | 0.01 | 4 | 6 | 0 |
| NO. 2 | 0.1 | 9 | 1 | 0 |
| NO. 3 | 1 | 10 | 0 | 0 |
| NO. 4 | 3 | 10 | 0 | 0 |
| NO. 5 | 5 | 10 | 0 | 0 |
| NO. 6 | 10 | 8 | 2 | 0 |
| NO. 7 | 20 | 6 | 4 | 0 |
| NO. 8 | 30 | 5 | 4 | 1 |

As is also clear from the results shown in Table 3, when the enzyme-inactivation-untreated germinated whole fat soybean powder (B) was added in an amount of 0.1 to 20% by mass, particularly in an amount of 1 to 5% by mass, the effect of improving the flavor could be observed. Although the case in which it was added in an amount of 30% by mass also exhibited the effect of improving the flavor to some extent, still an effect further improving the flavor could not be observed as compared with the case in which 10% by mass or 20% by mass was added.

### Verification Test 2: Verification Test on Amount of Added Enzyme-Inactivation-Untreated Ungerminated Whole Fat Soybean Powder (C)(i.e., Soybean Powders C+c)

After adding to the enzyme-inactivation-untreated ungerminated defatted soybean powder (c) (poorly denatured defatted soybean) (manufactured by Nisshin OilliO Group, Ltd., an article of trade “Soya Flour A”), the enzyme-inactivation-untreated ungerminated whole fat soybean powder (C) obtained in Production Example 6 in an amount accounting for 0.01 to 30% by weight of the ungerminated defatted soybean powder (c), water in an amount of ten times the total powder mass was added, and allowed to stand still at 30° C. for 2 hrs. Thereafter, an enzyme-inactivating treatment was carried out at 100° C. for 3 min, followed by drying with a spray drying process (preset temperature at the inlet: 180° C., preset temperature at the outlet: 75° C.), whereby soybean powders NO. 9 to NO. 16 were produced. Each of the produced soybean powders was added to hot water such that the concentration became 10% by mass, and was then stirred to make a sample beverage for evaluation. Evaluation on the flavor of the thus obtained sample beverage for evaluation was made according to the method explained above. The evaluation results are shown in Table 4.

TABLE 4
Table 4: Verification Test on Amount of Added Enzyme-
inactivation-untreated Ungerminated Whole Fat Soybean
Powder (C) obtained in Production Example 6

| | | Number | | |
|---|---|---|---|---|
| | Amount | of panelists | | |
| | of Addition | (persons) | | |
| Sample | (% by weight) | A | B | C |
| NO. 9 | 0.01 | 2 | 2 | 6 |
| NO. 10 | 0.1 | 6 | 2 | 2 |
| NO. 11 | 1 | 6 | 3 | 1 |
| NO. 12 | 3 | 6 | 3 | 1 |
| NO. 13 | 5 | 6 | 3 | 1 |
| NO. 14 | 10 | 6 | 3 | 1 |
| NO. 15 | 20 | 6 | 3 | 1 |
| NO. 16 | 30 | 5 | 4 | 1 |

As is also clear from the results shown in Table 4, when the enzyme-inactivation-untreated ungerminated whole fat soybean powder (C) was added in an amount of 0.1 to 20% by mass, an effect improving the flavor could be observed. Although the case in which it was added in an amount of 30% by mass also exhibited the effect improving the flavor to some extent, still an effect further improving the flavor could not be observed as compared with the case in which 10% by mass or 20% by mass was added.

Verification Test 3: Verification Test with Varying Contact Time in the Presence of Water (i.e., Soybean Powders B+c)

After adding to the enzyme-inactivation-untreated ungerminated defatted soybean powder (c) (poorly denatured defatted soybean) (manufactured by Nisshin OilliO Group, Ltd., an article of trade “Soya Flour A”), the enzyme-inactivation-untreated germinated whole fat soybean powder (B) (powdery material: germinated whole grain soymilk) obtained in Production Example 4 in an amount accounting for 5% by weight of the ungerminated defatted soybean powder (c), water was added in an amount of ten times the total powder mass, and allowed to stand still at 30° C. for 1 min to 36 hrs. Thereafter, an enzyme-inactivating treatment was carried out at 100° C. for 3 min, followed by drying with a spray drying process (preset temperature at the inlet: 180° C., preset temperature at the outlet: 75° C.), whereby soybean powders NO. 17 to NO. 25 were produced. Each of the produced soybean powders was added to hot water such that the concentration became 10% by mass, and was then stirred to make a sample beverage for evaluation. Evaluation on the flavor of the thus obtained sample beverage for evaluation was made according to the method explained above. The evaluation results are shown in Table 5. NO. 21 is identical with Example 2.

TABLE 5
Table 5: Verification Test with Varying Contact
Time in the Presence of Water

| | | Number | | |
|---|---|---|---|---|
| | | of panelists | | |
| | Contact | (persons) | | |
| Sample | Time | A | B | C |

| | | | | | |
|---|---|---|---|---|---|
| NO. 17 | 1 | min | 2 | 4 | 4 |
| NO. 18 | 10 | min | 6 | 4 | 0 |
| NO. 19 | 30 | min | 6 | 4 | 0 |
| NO. 20 | 1 | hour | 8 | 2 | 0 |
| NO. 21 | 2 | hrs | 10 | 0 | 0 |
| NO. 22 | 6 | hrs | 10 | 0 | 0 |
| NO. 23 | 12 | hrs | 10 | 0 | 0 |
| NO. 24 | 24 | hrs | 8 | 2 | 0 |
| NO. 25 | 36 | hrs | 5 | 5 | 0 |

As is also clear from the results shown in Table 5, when the enzyme-inactivation-untreated ungerminated defatted soybean powder (c) was brought in contact with the enzyme-inactivation-untreated germinated whole fat soybean powder (B) in the presence of water for 10 min to 24 hrs, an effect improving the flavor was observed. Particularly the contact time period for 2 hrs to 12 hrs resulted in a marked effect. However, taking into consideration of the production cost in actual production, the contact time period is preferably as short as possible.

### Comparative Example 2

### Test on Improvement of Flavor of Soymilk to which Flavor Improving Agent is not Added

Soybean (sold by Nisshin Shokai Co., Ltd., trade name “Enrei”) was soaked in water at room temperature for 12 hrs, whereby ungerminated soaked soybean was produced. To 10 kg of the thus resulting soaked soybean was added 20 kg, i.e., two times the mass of the soaked soybean, of water, and was then subjected to a grinding treatment twice with a Mass Colloider (manufactured by Masuko Sangyo Co., Ltd.), whereby bean slurry was produced. Here, the slit width of the Mass Colloider in the second treatment was predetermined as half of that in the first treatment. The thus resulting bean slurry was subjected to a centrifugal separation treatment (condition: 1500 rpm) to remove bean curd refuse. Thus, the solution obtained by removing bean curd refuse was provided. The solution obtained by removing bean curd refuse was subjected to an enzyme-inactivating treatment with a UHT sterilizer at 140° C. for 2 sec to produce the soymilk. The thus resulting soymilk was employed as a sample beverage for evaluation, and evaluation on the flavor was conducted according to the method described above. The evaluation results are shown in Table 6.

### Example 5

### Test on Improvement of Flavor 1 when Addition was Conducted During Production Step of Soymilk (i.e., Soybean Powders B+e2)

Soybean (sold by Nisshin Shokai Co., Ltd., trade name “Enrei”) was soaked in water at room temperature for 12 hrs, whereby ungerminated soaked soybean was produced. To 10 kg of the thus resulting soaked soybean was added 20 kg, i.e., two times the mass of the soaked soybean, of water, and was then subjected to a grinding treatment twice with a Mass Colloider (manufactured by Masuko Sangyo Co., Ltd.), whereby bean slurry was produced. Here, the slit width of the Mass Colloider in the second treatment was predetermined as half of that in the first treatment. The thus resulting bean slurry was subjected to a centrifugal separation treatment (condition: 1500 rpm) to remove bean curd refuse. Thus, the solution obtained by removing bean curd refuse (e2) was provided. To the solution obtained by removing bean curd refuse (e2) was added the enzyme-inactivation-untreated germinated whole fat soybean powder (B) (powdery material: germinated soymilk) obtained in Production Example 2 in an amount accounting for 10% by mass of the solid content of the solution (e2), and allowed to stand still at 25° C. for 3 hrs. Thereafter, an enzyme-inactivating treatment was carried out with a UHT sterilizer at 140° C. for 2 sec to produce the soymilk. The thus resulting soymilk was employed as a sample beverage for evaluation, and evaluation on the flavor was conducted according to the method described above. The evaluation results are shown in Table 6.

### Example 6

### Test on Improvement of Flavor 2 when Addition was Conducted During Production Step of Soymilk (i.e., Soybean Powders A+e2)

In a similar manner to Example 5, except that the enzyme-inactivation-treated germinated whole fat soybean powder (A) (powdery material: germinated soymilk) obtained in Production Example 3 was used in place of the enzyme-inactivation-untreated germinated whole fat soybean powder (B) (raw material: germinated soymilk) obtained in Production Example 2, a soymilk was produced. The thus resulting soymilk was employed as a sample beverage for evaluation, and evaluation on the flavor was conducted according to the method described above. The evaluation results are shown in Table 6.

### Example 7

### Test on Improvement of Flavor 3 when Addition was Conducted During Production Step of Soymilk (i.e., Soybean Powders B+e2)

In a similar manner to Example 5, except that the enzyme-inactivation-untreated germinated whole fat soybean powder (B) (powdery material: germinated whole grain soymilk) obtained in Production Example 4 was used in place of the enzyme-inactivation-untreated germinated whole fat soybean powder (B) (powdery material: germinated soymilk) obtained in Production Example 2, a soymilk was produced. The thus resulting soymilk was employed as a sample beverage for evaluation, and evaluation on the flavor was conducted according to the method described above. The evaluation results are shown in Table 6.

TABLE 6
Table 6: Results of Test on Improvement of Flavor when
Addition was Conducted During Production Step of Soymilk

| | | Number of | | |
|---|---|---|---|---|
| | | panelists | | |
| | | (persons) | | |
| Sample | | A | B | C |
| Comparative | Flavor Improving Agent not Added | 0 | 3 | 7 |
| Example 2 | | | | |
| Example 5 | Enzyme-inactivation-untreated | 10 | 0 | 0 |
| | germinated whole fat soybean | | | |
| | powder (powdery material: | | | |
| | germinated soymilk) obtained in | | | |
| | Production Example 2 | | | |
| Example 6 | Enzyme-inactivation-treated | 8 | 2 | 0 |
| | germinated whole fat soybean | | | |
| | powder (powdery material: | | | |
| | germinated soymilk) obtained in | | | |
| | Production Example 3 | | | |
| Example 7 | Enzyme-inactivation-untreated | 7 | 2 | 1 |
| | germinated whole fat soybean | | | |
| | powder (powdery material: | | | |
| | germinated whole grain soymilk) | | | |
| | obtained in Production Example 4 | | | |

As is clear from the results shown in Table 6, even though the agent of the present invention was added during the production step of the soymilk, an effect improving the flavor was exhibited, and particularly, the effect was markedly observed when the enzyme-inactivation-untreated germinated whole fat soybean powder (B) was added.

### Comparative Example 3

### Test on Improvement of Flavor of Whole Grain Soymilk to which Flavor Improving Agent is not Added

The whole grain soymilk produced in Production Example 7 was employed as a sample beverage for evaluation, and evaluation on the flavor was conducted according to the method described above. The evaluation results are shown in Tables 7 and 8.

### Example 8

### Test on Improvement of Flavor 1 when Addition was Conducted During Production Step of Whole Grain Soymilk (i.e., Soybean Powders B+e2)

Soybean (sold by Nisshin Shokai Co., Ltd., trade name “Enrei”) was soaked in water at room temperature for 12 hrs, whereby ungerminated soaked soybean was produced. To 10 kg of the thus resulting soaked soybean was added 20 kg, i.e., two times the mass of the soaked soybean, of water, and was then subjected to a grinding treatment twice with a Mass Colloider (manufactured by Masuko Sangyo Co., Ltd.), whereby bean slurry was produced. After homogenizing the thus resulting bean slurry by subjecting to a homogenizer treatment at a pressure of 15 MPa, the enzyme-inactivation-untreated germinated whole fat soybean powder (B) (powdery material: germinated soymilk) obtained in Production Example 2 was added to the bean slurry (e2) following homogenization, in an amount accounting for 10% by mass of the solid content of the bean slurry (e2), and allowed to stand still at 25° C. for 3 hrs. Thereafter, the enzyme-inactivating treatment was carried out with a UHT sterilizer at 140° C. for 2 sec, and whole grain soymilk was produced. The thus resulting whole grain soymilk was employed as a sample beverage for evaluation, and evaluation on the flavor was conducted according to the method described above. The evaluation results are shown in Table 7.

### Example 9

### Test on Improvement of Flavor 2 when Addition was Conducted During Production Step of Whole Grain Soymilk (i.e., Soybean Powders B+e2)

In a similar manner to Example 8, except that the enzyme-inactivation-untreated germinated whole fat soybean powder (B) (powdery material: germinated whole grain soymilk) obtained in Production Example 4 was used in place of the enzyme-inactivation-untreated germinated whole fat soybean powder (B) (powdery material: germinated soymilk) obtained in Production Example 2, a whole grain soymilk was produced. The thus resulting whole grain soymilk was employed as a sample beverage for evaluation, and evaluation on the flavor was conducted according to the method described above. The evaluation results are shown in Table 7.

### Example 10

### Test on Improvement of Flavor 3 when Addition was Conducted During Production Step of Whole Grain Soymilk (i.e., Soybean Powders A+e2)

In a similar manner to Example 8, except that the enzyme-inactivation-treated germinated whole fat soybean powder (A) (powdery material: germinated soymilk) obtained in Production Example 5 was used in place of the enzyme-inactivation-untreated germinated whole fat soybean powder (B) (powdery material: germinated whole grain soymilk) obtained in Production Example 2, a whole grain soymilk was produced. The thus resulting whole grain soymilk was employed as a sample beverage for evaluation, and evaluation on the flavor was conducted according to the method described above. The evaluation results are shown in Table 7.

TABLE 7
Table 7: Results of Test on Improvement of Flavor when
Addition was Conducted During Production Step of Whole
Grain Soymilk

| | | Number of | | |
|---|---|---|---|---|
| | | panelists | | |
| | | (persons) | | |
| Sample | | A | B | C |
| Comparative | Flavor Improving Agent not Added | 0 | 2 | 8 |
| Example 3 | (soymilk of Production Example 7) | | | |
| Example 8 | Enzyme-inactivation-untreated | 10 | 0 | 0 |
| | germinated whole fat soybean | | | |
| | powder (powdery material: | | | |
| | germinated soymilk) obtained in | | | |
| | Production Example 2 | | | |
| Example 9 | Enzyme-inactivation-untreated | 8 | 2 | 0 |
| | germinated whole fat soybean | | | |
| | powder (powdery material: | | | |
| | germinated whole grain soymilk) | | | |
| | obtained in Production Example 4 | | | |
| Example 10 | Enzyme-inactivation-treated | 7 | 2 | 1 |
| | germinated whole fat soybean | | | |
| | powder (powdery material: | | | |
| | germinated whole grain soymilk) | | | |
| | obtained in Production Example 5 | | | |

As is clear from the results shown in Table 7, even though the agent of the present invention was added during the production step of the whole grain soymilk, the effect improving the flavor was exhibited, and particularly, the effect was markedly observed when the enzyme-inactivation-untreated germinated whole fat soybean powder (B) was added.

### Example 11

### Test on Improvement of Flavor 1 when Addition was Conducted to Whole Grain Soymilk (i.e., Soybean Powders B+d2)

To the whole grain soymilk (d2) obtained in Production Example 7 was added the enzyme-inactivation-untreated germinated whole fat soybean powder (B) (powdery material: germinated soymilk) obtained in Production Example 2 in an amount accounting for 10% by mass of the whole grain soymilk (d2), and allowed to stand still at 25° C. for 3 hrs. Thereafter, an enzyme-inactivating treatment was carried out at 85° C. for 15 min, whereby whole grain soymilk was produced. The thus resulting whole grain soymilk was employed as a sample beverage for evaluation, and evaluation on the flavor was conducted according to the method described above. The evaluation results are shown in Table 8.

### Example 12

### Test on Improvement of Flavor 2 when Addition was Conducted to Whole Grain Soymilk (i.e., Soybean Powders B+d2)

In a similar manner to Example 11, except that the enzyme-inactivation-untreated germinated whole fat soybean powder (B) (powdery material: germinated whole grain soymilk) obtained in Production Example 4 was used in place of the enzyme-inactivation-untreated germinated whole fat soybean powder (B) (powdery material: germinated soymilk) obtained in Production Example 2, a whole grain soymilk was produced. The thus resulting whole grain soymilk was employed as a sample beverage for evaluation, and evaluation on the flavor was conducted according to the method described above. The evaluation results are shown in Table 8.

### Example 13

### Test on Improvement of Flavor 3 when Addition was Conducted to Whole Grain Soymilk (i.e., Soybean Powders A+d2)

In a similar manner to Example 11, except that the enzyme-inactivation-treated germinated whole fat soybean powder (A) (powdery material: germinated whole grain soymilk) obtained in Production Example 5 was used in place of the enzyme-inactivation-untreated germinated whole fat soybean powder (B) (powdery material: germinated soymilk) obtained in Production Example 2, a whole grain soymilk was produced. The thus resulting whole grain soymilk was employed as a sample beverage for evaluation, and evaluation on the flavor was conducted according to the method described above. The evaluation results are shown in Table 8.

TABLE 8
Table 8: Results of Test on Improvement of Flavor when
Addition was Conducted to Whole Grain Soymilk (d2)

| | | Number of | | |
|---|---|---|---|---|
| | | panelists | | |
| | | (persons) | | |
| Sample | | A | B | C |
| Comparative | Flavor Improving Agent not Added | 0 | 2 | 8 |
| Example 3 | (soymilk of Production Example | | | |
| | 7) | | | |
| Example 11 | Enzyme-inactivation-untreated | 10 | 0 | 0 |
| | germinated whole fat soybean | | | |
| | powder (powdery material: | | | |
| | germinated soymilk) obtained in | | | |
| | Production Example 2 | | | |
| Example 12 | Enzyme-inactivation-untreated | 6 | 4 | 0 |
| | germinated whole fat soybean | | | |
| | powder (powdery material: | | | |
| | germinated whole grain soymilk) | | | |
| | obtained in Production Example 4 | | | |
| Example 13 | Enzyme-inactivation-treated | 7 | 3 | 0 |
| | germinated whole fat soybean | | | |
| | powder (powdery material: | | | |
| | germinated whole grain soymilk) | | | |
| | obtained in Production Example 5 | | | |

As is clear from the results shown in Table 8, even though the agent of the present invention was added during the production step of the whole grain soymilk, the effect improving the flavor was exhibited, and particularly, the effect was markedly observed when the enzyme-inactivation-untreated germinated whole fat soybean powder (B) was added.

### Comparative Example 4

### Soybean Powder to which Flavor Improving Agent is not Added

To the enzyme-inactivation-treated ungerminated whole fat soybean powder (a) (manufactured by Nisshin OilliO Group, Ltd., an article of trade “Soya Flour alpha plus HS-600”) was added water in an amount of ten times the total powder mass, and after allowing to stand still at 30° C. for 2 hrs, heat treatment was carried out at 100° C. for 3 min. Thereafter, soybean powder was produced by a drying treatment with a spray drying process (preset temperature at the inlet: 180° C., preset temperature at the outlet: 75° C.). The produced soybean powder was added to hot water such that the concentration became 10% by mass, and was then stirred to make a sample beverage for evaluation. Evaluation on the flavor of the thus obtained sample beverage for evaluation was made according to the method explained above. The evaluation results are shown in Table 9.

### Example 14

### Test on Improvement of Flavor 3 Using Enzyme-Inactivation-Treated Germinated Whole Fat Soybean Powder (A) (i.e., Soybean Powders A+a)

To the enzyme-inactivation-treated ungerminated whole fat soybean powder (a) (manufactured by Nisshin OilliO Group, Ltd., an article of trade “Soya Flour alpha plus HS-600”) was added the enzyme-inactivation-treated germinated whole fat soybean powder (A) (powdery material: germinated soymilk) obtained in Production Example 3 in an amount accounting for 5% by mass of the ungerminated whole fat soybean powder (a), and then mixed. The thus resulting soybean powder was added to hot water such that the concentration became 10% by mass, and was then stirred to make a sample beverage for evaluation. Evaluation on the flavor of the thus obtained sample beverage for evaluation was made according to the method explained above. The evaluation results are shown in Table 9.

### Example 15

### Test on Improvement of Flavor 3 Using Enzyme-Inactivation-Untreated Germinated Whole Fat Soybean Powder (B) (i.e., Soybean Powders B+a)

After adding to the enzyme-inactivation-treated ungerminated whole fat soybean powder (a) (manufactured by Nisshin OilliO Group, Ltd., an article of trade “Soya Flour alpha plus HS-600”), the enzyme-inactivation-untreated germinated whole fat soybean powder (B) (powdery material: germinated whole grain soymilk) obtained in Production Example 4 in an amount accounting for 5% by mass of the ungerminated whole fat soybean powder (a), water in an amount of ten times the total powder mass was added thereto, and allowed to stand at 30° C. for 2 hrs. Thereafter, a heat treatment was carried out at 100° C. for 3 minutes, followed by additional drying treatment with an additional spray drying process (preset temperature at the inlet: 180° C., preset temperature at the outlet: 75° C.), whereby soybean powder was produced. The produced soybean powder was added to hot water such that the concentration became 10% by mass, and was then stirred to make a sample beverage for evaluation. Evaluation on the flavor of the thus obtained sample beverage for evaluation was made according to the method explained above. The evaluation results are shown in Table 9.

### Example 16

### Test on Improvement of Flavor 1 Using Enzyme-Inactivation-Untreated Ungerminated Whole Fat Soybean Powder (C) (i.e., Soybean Powders C+a)

After adding to the enzyme-inactivation-treated ungerminated whole fat soybean powder (a) (manufactured by Nisshin OilliO Group, Ltd., an article of trade “Soya Flour alpha plus HS-600”), the enzyme-inactivation-untreated ungerminated whole fat soybean powder (C) obtained in Production Example 6 in an amount accounting for 5% by mass of the ungerminated whole fat soybean powder (a), water in an amount of ten times the total powder mass was added thereto, and allowed to stand at 30° C. for 2 hrs. Thereafter, a heat treatment was carried out at 100° C. for 3 minutes, followed by additional drying treatment with an additional spray drying process (preset temperature at the inlet: 180° C., preset temperature at the outlet: 75° C.), whereby soybean powder was produced. The produced soybean powder was added to hot water such that the concentration became 10% by mass, and was then stirred to make a sample beverage for evaluation. Evaluation on the flavor of the thus obtained sample beverage for evaluation was made according to the method explained above. The evaluation results are shown in Table 9.

TABLE 9
Table 9: Results of Test on Improvement of Flavor when
Addition was Conducted to enzyme-inactivation-treated
Ungerminated Whole Fat Soybean Powder (a)

| | | Number of | | |
|---|---|---|---|---|
| | | panelists | | |
| | | (persons) | | |
| Sample | | A | B | C |
| Comparative | Flavor Improving Agent not Added | 0 | 0 | 10 |
| Example 4 | | | | |
| Example 14 | Enzyme-inactivation-treated | 7 | 3 | 0 |
| | germinated whole fat soybean powder | | | |
| | (powdery material: germinated | | | |
| | soymilk) obtained in Production | | | |
| | Example 3 added | | | |
| Example 15 | Enzyme-inactivation-untreated | 10 | 0 | 0 |
| | germinated whole fat soybean powder | | | |
| | (powdery material: germinated whole | | | |
| | grain soymilk) obtained in | | | |
| | Production Example 4 added | | | |
| Example 16 | Enzyme-inactivation-untreated | 6 | 3 | 1 |
| | ungerminated whole fat soybean | | | |
| | powder obtained in Production | | | |
| | Example 6 added | | | |

As is clear from Table 9, when the soybean powder of the present invention was added to the enzyme-inactivation-treated ungerminated whole fat soybean powder (a), the effect improving the flavor was exhibited, and particularly, the effect was markedly observed when the enzyme-inactivation-untreated germinated whole fat soybean powder (B) of Example 15 was added.

The flavor improving agent for food of the present invention can be extensively used in the food field involving soybean protein, enzyme-inactivation-treated ungerminated whole fat soybean powder (a), enzyme-inactivation-treated ungerminated defatted soybean powder (b), enzyme-inactivation-untreated ungerminated defatted soybean powder (c), soybean processed food, wheat protein, wheat flour, wheat flour processed food, milk protein, dairy product, processed marine product, processed livestock product, and the like.

What is claimed is:

1. A method of using at least one selected from germinated whole fat soybean powder, and enzyme-inactivation-untreated ungerminated whole fat soybean powder to produce a flavor improved food.

2. The method according to claim 1, wherein
the germinated whole fat soybean powder is a product in a form of a powder of one selected from a germinated soymilk, and a germinated whole grain soymilk.

3. The method according to claim 1, wherein
the germinated whole fat soybean powder is a product not subjected to an enzyme-inactivation treatment.

4. The method according to claim 3, wherein
a composition is formed by adding at least one kind of soybean powder selected from enzyme-inactivation-untreated germinated whole fat soybean powder, and enzyme-inactivation-untreated ungerminated whole fat soybean powder, to one selected from a food, and an intermediary material of the food obtained in a production step of the food, in an amount equal to 0.1 to 20% by mass of one selected from a solid content of the food, and a solid content of the intermediary material of the food; followed by keeping the composition in the presence of moisture for 10 min to 30 hrs to form a moisture treated composition; followed by subjecting the moisture treated composition to an enzyme-inactivation treatment.

5. The method according to claim 1, wherein
the food is any one selected from the group consisting of soybean protein, enzyme-inactivation-treated ungerminated whole fat soybean powder, enzyme-inactivation-treated ungerminated defatted soybean powder, enzyme-inactivation-untreated ungerminated defatted soybean powder, soybean processed food, wheat protein, wheat flour, wheat flour processed food, milk protein, a dairy product, a processed marine product, and a processed livestock product.

6. The method according to claim 2, wherein
the food is any one selected from the group consisting of soybean protein, enzyme-inactivation-treated ungerminated whole fat soybean powder, enzyme-inactivation-treated ungerminated defatted soybean powder, enzyme-inactivation-untreated ungerminated defatted soybean powder, soybean processed food, wheat protein, wheat flour, wheat flour processed food, milk protein, a dairy product, a processed marine product, and a processed livestock product.

7. The method according to claim 3, wherein
the food is any one selected from the group consisting of soybean protein, enzyme-inactivation-treated ungerminated whole fat soybean powder, enzyme-inactivation-treated ungerminated defatted soybean powder, enzyme-inactivation-untreated ungerminated defatted soybean powder, soybean processed food, wheat protein, wheat flour, wheat flour processed food, milk protein, a dairy product, a processed marine product, and a processed livestock product.

8. The method according to claim 4, wherein
the food is any one selected from the group consisting of soybean protein, enzyme-inactivation-treated ungerminated whole fat soybean powder, enzyme-inactivation-treated ungerminated defatted soybean powder, enzyme-inactivation-untreated ungerminated defatted soybean powder, soybean processed food, wheat protein, wheat flour, wheat flour processed food, milk protein, a dairy product, a processed marine product, and a processed livestock product.

9. A germinated whole fat soybean powder that is a germinated soybean powder, and is not subjected to an enzyme-inactivation treatment.

10. The germinated whole fat soybean powder according to claim 9, wherein
the germinated whole fat soybean powder is a product in a form of a powder of one selected from an enzyme-inactivation-untreated germinated soymilk, and an enzyme-inactivation-untreated germinated whole grain soymilk.

11. A method for producing an improved flavor soybean powder, comprising the steps of:
(1) forming a moisture treated composition by bringing at least one kind of a first soybean powder selected from enzyme-inactivation-treated ungerminated whole fat soybean powder, enzyme-inactivation-treated ungerminated defatted soybean powder, and enzyme-inactivation-untreated ungerminated defatted soybean powder into contact with an amount, equal to 0.1 to 20% by mass of an amount of the first soybean powder, of one kind of a second soybean powder selected from enzyme-inactivation-untreated germinated whole fat soybean powder, and enzyme-inactivation-untreated ungerminated whole fat soybean powder, in the presence of moisture for 10 min to 30 hrs;
(2) subjecting the moisture treated composition to an enzyme-inactivation treatment to form an enzyme-inactivation moisture treated composition; and
(3) subjecting the enzyme-inactivation moisture treated composition to a drying treatment.

12. The method for producing the improved flavor soybean powder according to claim 11, wherein
the enzyme-inactivation-untreated germinated whole fat soybean powder is a product in a form of a powder of one selected from an enzyme-inactivation-untreated germinated soymilk, and an enzyme-inactivation-untreated germinated whole grain soymilk.

13. The method for producing the improved flavor soybean powder according to claim 11, wherein
the enzyme-inactivation-untreated ungerminated whole fat soybean powder is a product in a form of a powder of one selected from an enzyme-inactivation-untreated soymilk, and an enzyme-inactivation-untreated whole grain soymilk.

14. A method for producing an improved flavor food, comprising the steps of:
forming a composition by adding at least one kind of soybean powder selected from enzyme-inactivation-untreated germinated whole fat soybean powder, and enzyme-inactivation-untreated ungerminated whole fat soybean powder, to one selected from a food, and an intermediary material of the food obtained in a production step of the food, in an amount equal to 0.1 to 20% by mass of one selected from a solid content of the food, and a solid content of the intermediary material of the food; followed by keeping the composition in the presence of moisture for 10 min to 30 hrs to form a moisture treated composition; followed subjecting the moisture treated composition to an enzyme-inactivation treatment.

15. The method for producing the improved flavor food according to claim 14,
wherein the food is one selected from a soymilk, and a whole grain soymilk.

16. The method for producing the improved flavor food according to claim 14, wherein
the production step of the food is a step of producing a soymilk, and the intermediary material of the food is a liquid prepared by removing bean curd refuse from a bean slurry obtained by grinding soybeans.

17. The method for producing the improved flavor food according to claim 14, wherein
the production step of the food is a step of producing a whole grain soymilk, and the intermediary material of the food is a bean slurry obtained by grinding soybeans.
